(19) United States
(12) Patent Application Publication
(10) Pub. No.: US 2026/0216627 A1
(43) Pub. Date: Jul. 30, 2026

(54) Filters and Filtration Systems

(71) Applicant: Walk Industrial, Inc., Murrieta, CA (US)

(72) Inventors: Tyler Walk, Mattoon, IL (US); Mitch Walk, Temecula, CA (US)

(21) Appl. No.: 19/178,543

(22) Filed: Apr. 14, 2025

Related U.S. Application Data
(60) Provisional application No. 63/633,741, filed on Apr. 13, 2024.
(60) Provisional application No. 63/735,577, filed on Dec. 18, 2024.

(51) Int. Cl. B01D 46/00; B01D 46/10

(52) U.S. Cl. CPC B01D 46/001; B01D 46/10

(57) ABSTRACT

A filter assembly includes a sleeve, a filter, and a retention member. The sleeve is sized and configured to retain the filter, which is configured to facilitate the flow of air through and upstream side and a downstream side thereof. The filter includes at least one sidewall which extends from the upstream side to the downstream side and includes filter media. The filter further includes a back wall disposed at the downstream side of the main filter which also includes filter media. A back wall aperture is defined between the back wall and the sleeve. The retention member is positioned through the filter media adjacent the back wall, and is configured to define an aperture between an edge of the back wall and the sleeve. The aperture facilitates the flow of air therethrough.

### CROSS-REFERENCE TO RELATED APPLICATIONS

The present application claims priority to U.S. Provisional Application Ser. No. 63/735,577, filed Dec. 18, 2024, and U.S. Provisional Application Ser. No. 63/633,741, filed Apr. 13, 2024, the entirety of each of which is hereby incorporated by reference.

### FIELD OF THE DISCLOSURE

The field of the disclosure relates generally to filter assemblies for filtering particulate material from a flow.

### BACKGROUND

Generally, filters have been fabricated to provide a single surface which filters particulates from a fluid (e.g., air). As the single surface fills with particulates, the efficiency of the filter begins to decline. Accordingly, there is a need for a filter that increases the useful life of known filters.

### SUMMARY

In one aspect, a filter assembly is provided. The filter assembly includes a sleeve, a filter, and a retention member. The sleeve is sized and configured to retain the filter, which is configured to facilitate the flow of air through and upstream side and a downstream side thereof. The filter includes at least one sidewall which extends from the upstream side to the downstream side and includes filter media. The filter further includes a back wall disposed at the downstream side of the main filter which also includes filter media. A back wall aperture is defined between the back wall and the sleeve. The retention member is positioned through the filter media adjacent the back wall, and is configured to define an aperture between an edge of the back wall and the sleeve. The aperture facilitates the flow of air therethrough.

In another aspect, a filter assembly is provided which includes a sleeve and a retention member. The sleeve is sized and configured to retain a filter, and defines a number of apertures. The retention member is inserted through the apertures of the sleeve, and is fixedly secured through the sleeve. The retention member is configured to substantially retain the filter when a force is applied to the filter assembly.

The present disclosure has other aspects as described herein below.

### BRIEF DESCRIPTION OF THE DRAWINGS

FIG. 1 is a schematic illustration of an exemplary filtration system.

FIG. 2 is a front perspective view of a filter assembly for use with the filtration system of FIG. 1.

FIG. 3 is a rear perspective view of the filter assembly of FIG. 2.

FIGS. 4 and 5 are perspective views of a filter used in the filter assembly of FIG. 2.

FIG. 6 is a rear perspective view of the filter assembly of FIG. 2, including a filter shown in FIG. 4.

FIG. 6A is a rear perspective view of the filter assembly of FIG. 2 including a filter shown in FIG. 4.

FIG. 7 is a front view of a rear support member for use with the filter of FIGS. 4 and 5.

FIG. 8 is a front view of a front support member for use with the filter of FIGS. 4 and 5.

FIG. 8A is a front perspective view of the assembly of FIG. 2.

FIG. 9 is a front perspective view of the assembly of FIG. 2.

FIG. 10 is a perspective view of an alternative filter assembly for use in the system of FIG. 1.

FIG. 11. is a rear perspective view of a filter assembly of FIG. 2 including an alternative sleeve.

FIG. 12 is a perspective view of a housing and filter sleeve for use in the assembly of FIG. 2, in a semi collapsed form.

FIG. 13 is a front perspective view of an alternative housing for use with the system of FIG. 1.

FIG. 14 is a front perspective view of multiple assemblies inserted into a mobile unit of FIG. 1.

FIG. 15A is a front perspective view of a filter array for use with a housing of FIG. 13.

FIG. 15B is a top view of the filter array of FIG. 15A in a first configuration.

FIG. 15C is a top view of the filter array of FIG. 15A in a second configuration.

FIG. 15D is a top view of the filter array of FIG. 15A in a third configuration.

FIG. 15E is a top view of the filter array of FIG. 15A in a fourth configuration.

FIG. 16 is an exploded view of an alternative filter assembly for use in the system of FIG. 1.

FIG. 17A is a top view of ledge frame for use with the assembly of FIG. 16.

FIG. 17B is a top view of an alternative ledge frame for use with the assembly of FIG. 16.

FIG. 17C is a perspective view of an alternative ledge frame for use with the assembly of FIG. 16.

FIG. 18 is a perspective view of the assembly of FIG. 16 utilizing an alternative filter retention member.

FIG. 19 is a perspective view of an alternative assembly utilizing the filter retention member of FIG. 18.

FIG. 20A is a top view of a retention member for use with the sleeve of FIG. 19.

FIG. 20B is a perspective view of a retention member secured to itself for use in the sleeve of FIG. 19.

FIG. 21 is a perspective view of an alternative sleeve for with the assembly of FIG. 16.

FIG. 22A is a top view of a multi-piece frame in a separated configuration.

FIG. 22B is a top view of the multi-piece frame of FIG. 22A, but is in an assembled configuration.

FIG. 23A is a perspective view of a multi-piece filter sleeve in a compact configuration.

FIG. 23B is a perspective view of the multi-piece filter sleeve of FIG. 23A, but is in a pre-assembly configuration.

FIG. 23C is a perspective view of the multi-piece filter sleeve of FIG. 23A, but is in an assembled configuration.

FIG. 24 is a perspective view of a flexible sleeve assembly.

### DETAILED DESCRIPTION

Provided herein are embodiments of a filter configured for filtering a flowable substance (e.g., air, gas, fluid, and/or liquid) to remove unwanted material (e.g., particulates and/or contaminants) therefrom. The embodiments described herein maximize the removal of particulates (e.g., paint, stains, dust/lint, pet dander, pollen, dust mite debris, mold spores, bacteria, microscopic allergens, virus carriers, smoke, odor, smog particles, metal, plastic, sludge, oil) from the flowable substance.

As used herein the term “filter media” refers to any material capable of removing particulates from a flowable substance (i.e., air/gas or fluid/liquid) including, but not limited to, polyester, thermal or resin bonded polyester, polypropylene, polyurethane, polyethylene, polyethylene foam, polyurethane foam, polyphenylene sulfide, polyolefin plastic, coal, glass, micro glass, spun glass, animal hair, organic fiber, fiberglass, acrylic fiber, paper, paper poly, cotton, nylon, Teflon, Aramid, felt, metal, fiber blend, wood, plastic, cardboard, or any combination thereof. In some embodiments, the filter media is electrostatic in that the filter media is configured to generate, produce, and/or hold an electrical charge which enables the filter and/or filter media to attract, capture, and/or hold particulate. The filter media is fabricated (e.g., configured) to filter and/or trap particulates including, but not limited to, lint, pollen, dust mites, mold, bacteria, smoke, smog, and/or droplet nuclei. In some embodiments, the filter includes a tackifer or binder to help hold particulates in suspension and to provide the filter media a more uniform configuration, enabling it to attract and/or hold unwanted particulates. Additionally, the filter media can have any minimum efficiency reporting value (MERV) in the range of 1-16 that is determined for a particular application. The filter media described herein may be fabricated from a single layer of uniform density, graduated density, or conformed density/shape or form (i.e., denier), and may also be fabricated from multiple layers of media such that the media is multi-denier or multi-staged. It should also be noted that any filter and/or filter media described herein may be finished to enhance the effectiveness of the filter media. Example finishes include, but are not limited to, singed (e.g., open flame melting of one side of the media), glazed (e.g., heat melting of one side of the media), oleophobic (e.g., having a water and/or oil repellent finish), fire retardant, acid resistant, anti-static, mold/mildew resistant, moisture resistant, and/or microbial growth resistant or any combination thereof. In some embodiments, the filter media may be supported by a mesh, adhesive, or wiring to prevent media deformation as forces are exerted thereon. As used herein, the terms “retention member,” “frame,” “ledge frame,” “baffle frame,” and “filter frame” refer to a structure which supports the filter media or a complete filter. The “retention member.” “frame,” “ledge frame,” “baffle frame,” or “filter frame” may be fabricated from any material capable of providing support (e.g., flexible or rigid support) to the filter media, including, acrylonitrile (acryllic), polypropylene, nylon, metal, wood, glass, organic fiber, cotton, polyester, rubber, unplasticized PVC (PVC-U), chlorinated PVC (C-PVC), molecular oriented PVC (PVC-O) high impact PVC (PVC-Hi), polymeric substance, and/or plastic, or any combination of one or more materials provided herein. The “retention member,” “frame,” “ledge frame,” “baffle frame,” and “filter frame” may be in the form of a strap, rope, or cord fabricated from a material described herein. Additionally, in the form of a strap, rope, or cord, the “retention member,” “frame,” “ledge frame,” “baffle frame,” and “filter frame” may be fabricated to be elastic, stretchable, or substantially non-stretchable. In an exemplary embodiment, the “retention member,” “frame,” “ledge frame,” “baffle frame,” and/or “filter frame” are fabricated from a material which is incinerable (e.g., combustible, burnable), such that the material is configured to be destroyed in the event that it is burned (e.g., for disposal after use).

As used herein, the terms “void,” “cavity,” “aperture,” and “plenum” each refer, in general, to an empty space defined by a portion of filter media that is of sufficient size to allow some flowable substance (e.g., a fluid) to pass therethrough without filtering the desired particulate from the flowable substance. It should be noted that “voids” and “cavities” are separate and apart from any space or spaces within a filter media which exist due to media formation (e.g., mesh or web of fibers), such as interfibrous space in the mesh or web of the media.

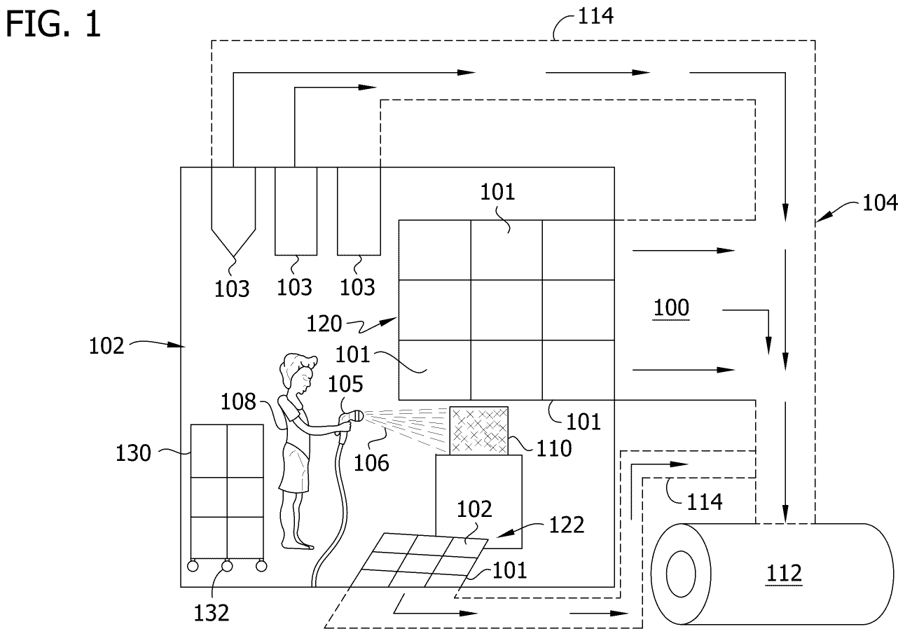

Referring to FIG. 1, a schematic illustration of an exemplary filtration system (broadly, system) is provided, and is generally indicated at reference number 100. The system 100 includes a plurality of filter assemblies 101 constructed according to one or more teachings of the present disclosure. The filter assemblies 101 are positioned in an application area or spray booth 102 having at least one ventilation system 104 for the removal of sprayed coatings 106 (e.g., paint, stain, powder) from the air. The filter assemblies 101 are coupled to the ventilation system 104 and are in fluid communication therewith, such that a downdraft and/or suction force provided by one or more motors or blowers 112 of the ventilation system forces air in the booth 102 to move through the filter assemblies. In one embodiment, the filter assemblies 101 are coupled directly to the motor or blower 112 of the ventilation system 104. Alternatively, the filter assemblies 101 are coupled to an air channel or duct 114 that is in fluid communication with the booth 102 and the motor or blower 112.

The filtration system 100 includes a plurality of filter assemblies 101. Alternatively, the system 100 can be a single filter assembly 101 that is coupled to the ventilation system 104. In some embodiments, the filter assembly 101 is positioned in a grid 120; however, the assemblies 101 can be arranged in any orientation which facilitates filtration as described herein. In some embodiments, the filter assemblies 101 are arranged on or within a wall, as shown at the grid 120; however, the filter assemblies 101 can also be installed in the ceiling or floor, as shown at grid 122. In some embodiments, the filter assembly 101 is a mobile unit 130 (broadly, unit) configured to be moveable within the area or booth 102. In such embodiments, the unit 130 includes wheels or casters 132 which enable the unit to be moved or swapped from being fluidly coupled to the ventilation system 104 with other units to allow filters to be installed and/or removed therefrom. This increases efficiency and decreases downtime for the system 100. In some such embodiments, the units 130 are slidably installed on a track within the booth 102.

In one embodiment, each filter assembly 101 has a 20 inch by 20 inch (20″×20″, 50.8 cm×50.8 cm) dimension (e.g., a square configuration). Alternatively, the filter assembly 101 may have any shape (e.g., a rectangular shape, a circular shape, an oval shape, etc.). In an exemplary embodiment, the filtration system 100 includes a frame configured to retain the filter assembly. In such an embodiment, the filter assembly 101 is located within the frame by sliding filters and/or filter sleeves into the assembly while the assembly is retained in the frame (e.g., by a friction fit). In alternative embodiments, the filter assembly 101 is coupled to the filtration system 100 and/or the frame by strapping, clamping, cording, or locking. The filter assembly 101 may be arranged in other ways.

In some embodiments, for example the embodiment shown at FIG. 1, the filtration system 100 includes ceiling-mounted filter assemblies 103 which extend downwardly into the booth 102. Like the filter assemblies 101, the ceiling-mounted filter assemblies 103 are coupled to an air channel or duct 114 which is in fluid communication with the booth 102 and the motor or blower 112; however, in alternative embodiments, the ceiling-mounted filter assemblies 103 are coupled directly to the motor or blower 112 of the ventilation system 104.

In the exemplary embodiment shown at FIG. 1, a user 108 sprays the coating 106 (e.g., paint or stain) from a coating apparatus 105 to coat an object 110. In some embodiments, the coating apparatus 105 is an air spray gun; however, in alternative embodiments, the coating apparatus 105 may be any applicator configured to provide a coat to the object 110. Coatings 106 that do not attach or adhere (e.g., bind) to the surface of the object 110 are forced through the filtration system 100, whereby particulates in the air are substantially filtered out (e.g., removed) from the air as it passes through the filter assemblies 101.

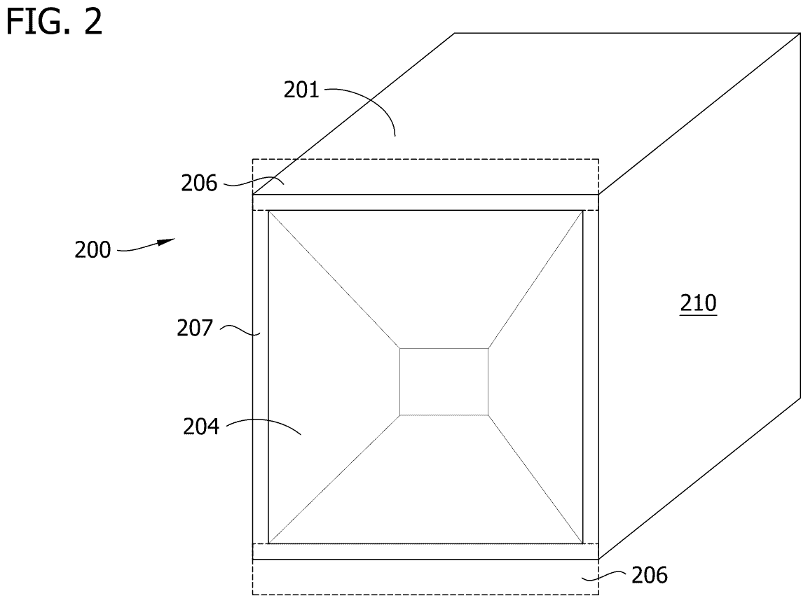

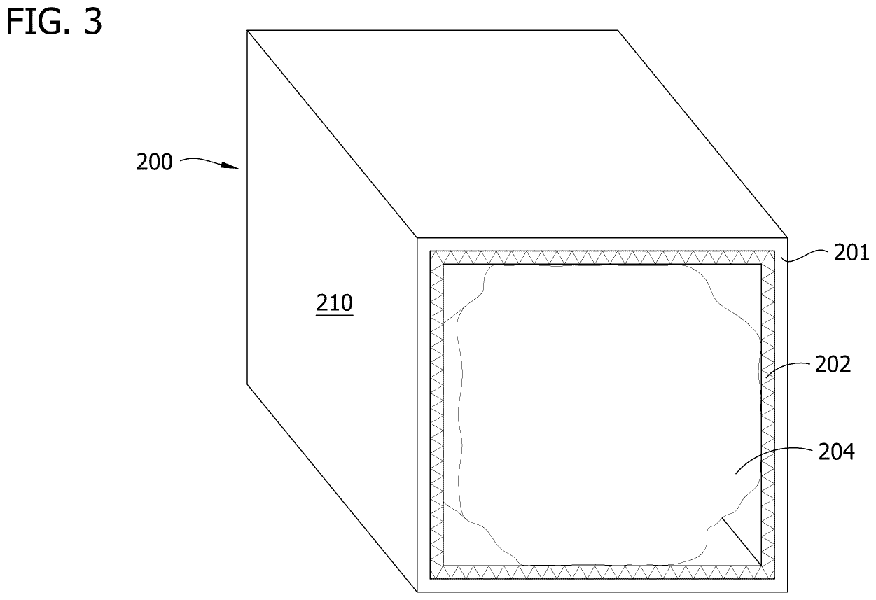

FIGS. 2 and 3 show one embodiment of a filter assembly 200 (e.g., the filter assembly 101 of FIG. 1) which is configured for use with (e.g., compatible with) the filtration system 100 of FIG. 1. The filter assembly 200 (broadly, assembly) includes an assembly housing 201 (broadly, housing) and a filter sleeve 202 configured to be slidably removed from within the housing. The filter sleeve 202 is configured to substantially secure and/or retain (e.g., hold) a filter 204 within the housing 201. In some embodiments, the housing 201 includes a grid retention member 206 extending therefrom. In one embodiment, the grid retention member 206 extends from the housing 201 in a single unitary piece. In an alternative embodiment, multiple grid retention members 206 extend from front edges 207 of the housing 201. The housing 201 may include any number of grid retention members 206 extending from the edges 207 and/or sidewalls 210 thereof (e.g., one grid retention member, two grid retention members, three grid retention members, four grid retention members, etc.). In some embodiments, the grid retention members 206 are flexible such that the housing 201 can be positioned at various depths within the grid due to the flexibility of the grid retention members 206. In an alternative embodiment, one or more grid retention members 206 rigidly extend from the sidewalls 210 of the housing 201. In such an embodiment, the angle formed by the grid retention member 206 and the sidewall 210 can be any angle that facilitates securement of the filter assembly 200 within a grid system including, but not limited to, any angle in the range of 15° to 170° (e.g., a 45° angle). In some embodiments, the grid retention member 206 is removable and/or capable of being coupled or attached to the filter sleeve 202. In some embodiments, the grid retention member 206 is a grid cover as described in United States Patent Application 2020/0276530, which is incorporated by reference herein in its entirety. The grid retention member 206, housing 201, and filter sleeve 202 may be manufactured from material such as the plastic, cardboard, styrofoam, bioplastics, PLA (Polylactic acid), PBAT (polybutylene adipate terephthalate), PET (polyethylene terephthalate), HDPE (high-density polyethylene), LDPE (low-density polyethylene), PE (polyethylene), seaweed, hemp, mycelium, cornstarch, wood, metal, polypropylene, recycled polypropylene, plant materials, or any combination thereof. In some embodiments, the material is corrugated. In an exemplary embodiment, the housing 201 and the filter sleeve 202 are fabricated from a corrugated plastic. In some embodiments, the materials of the grid retention member 206, housing 201, and filter sleeve 202 are the same material. Alternatively, the grid retention member 206, housing 201, and filter sleeve 202 can be fabricated from different materials as described herein.

In an exemplary embodiment, the filter sleeve 202 is configured to be removable from the housing 201 in a slidable manner. In some embodiments, the filter 204 includes a front baffle extending across an aperture.

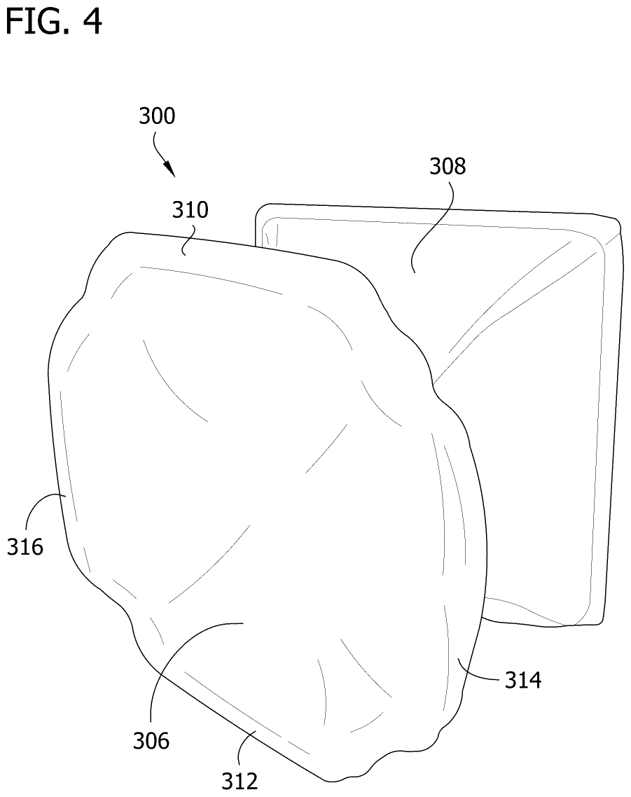

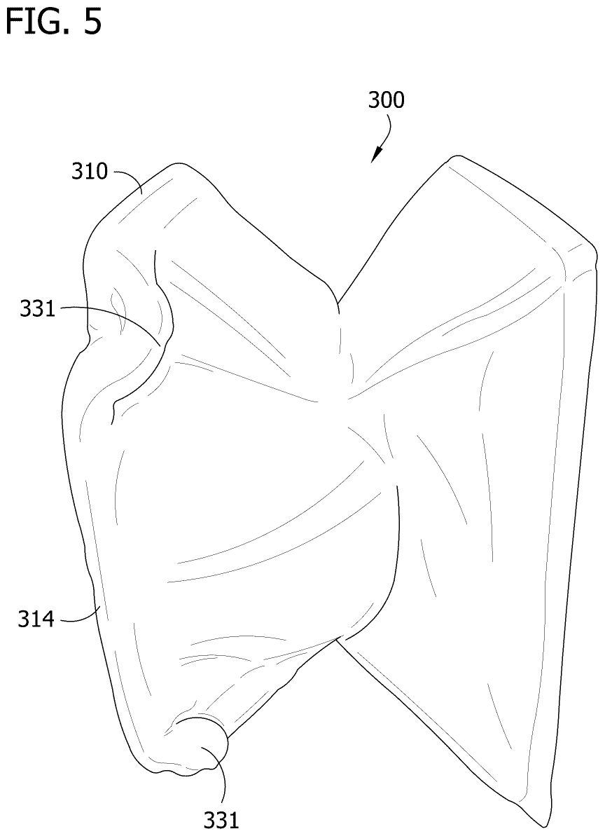

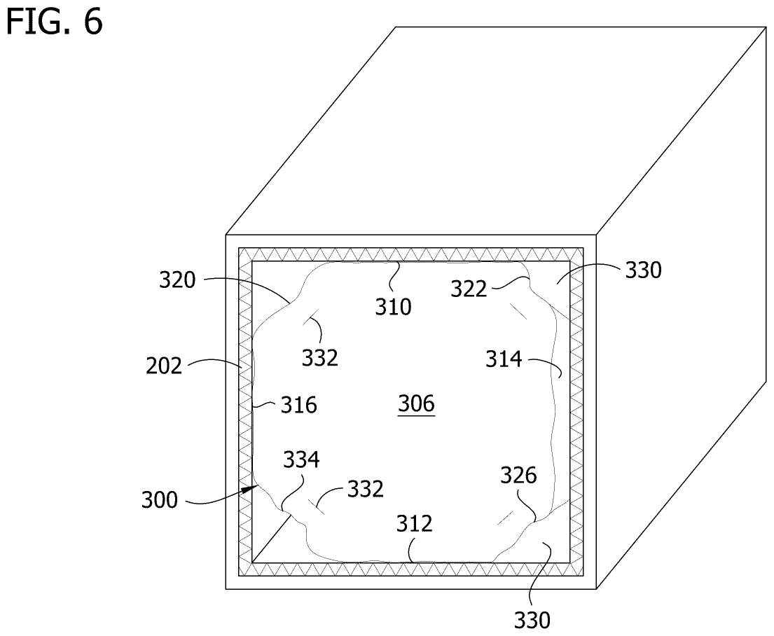

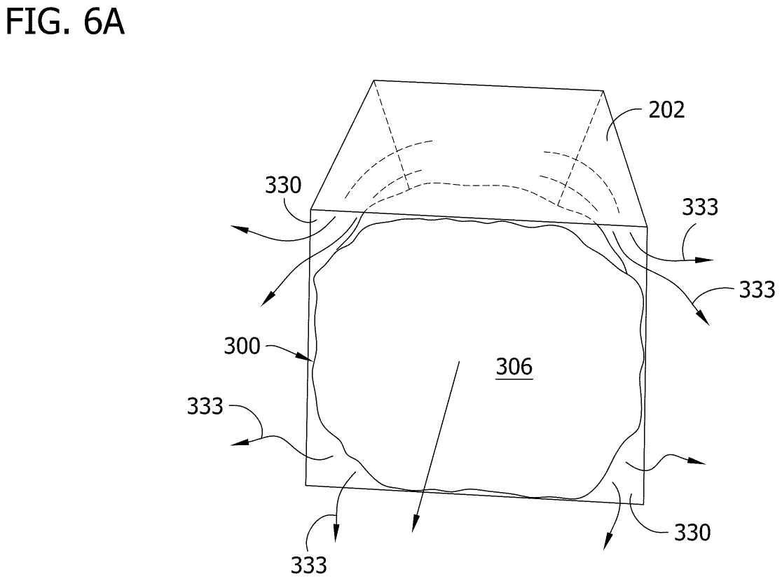

Referring now to FIGS. 4-6A, FIGS. 4 and 5 show one embodiment of a filter 300 configured for use with the filter assembly 200 of FIG. 2. FIG. 6 shows a filter 300 positioned within the filter sleeve 202, and FIG. 6A shows air flow through the filter assembly 200 of FIG. 6. In an exemplary embodiment, the filter 300 is formed from filter media and includes a body having a front side 302 (e.g., an upstream side) defining a first aperture 304, a back wall 306 (e.g., a downstream wall) at an opposite longitudinal end of the filter, and at least one side wall 308 extending from the front side to the back wall. Together, the front side 302, back wall 306, and at least one side wall 308 define a filter plenum through which the flowable substance to be filtered flows. The back wall 306 is defined by a back top edge 310, a back bottom edge 312, a back first side edge 314, and a back second side edge 316. In one embodiment, a first top connection edge 320 extends from the top edge 310 to the second side edge 316, while a second top connection edge 322 extends from the top edge 310 to the first edge 314. Likewise, in such an embodiment, a first bottom connection edge 324 extends from the second side edge 316 to the bottom edge 312, while a second bottom connection edge 326 extends from the first side edge 314 to the bottom edge 312.

The filter 300 is positioned within the filter sleeve 202 to form free air apertures 330 extending from each of edges 320, 322, 324, and 326 to filter sleeve. The free air apertures 330 of the assembly 200 enable the flow of air therethrough if the back wall 306 becomes saturated with debris (e.g., if the back wall becomes obstructed, congested, clogged, etc.) and can no longer filter or vent air. These free air apertures 330 allow air to exit from all different parts of the filter 300. In some embodiments, the back wall 306 is formed as a square or rectangle, and corners of two adjacent edges (e.g., the top edge 310 and the first edge 314) are folded over the back wall 306, while a securement member 332 is secured through the back wall and corner 331 to form a free air aperture 330. The securement member 332 can be any member configured to retain the filter media in place to form a free air aperture 330, and may be assembled in a variety of ways (e.g., stitching, gluing, staking, heat staking, ultrasonic welding, pinning, stapling, etc.). In some embodiments, the back wall 306 is formed in a predetermined shape to form the free air apertures 330 when positioned in the filter sleeve 202 and/or the housing 201. In an exemplary embodiment, the free air apertures 330 are substantially triangular. However, in alternative embodiments, the free air apertures 330 are formed to have alternate shapes which facilitate air flow through the assembly 200 (e.g., a circle shape, a square shape, a rectangle shape, a octagon shape, an oval shape, etc.). As particulates begin to accumulate at the inner side of the back wall 306, airflow and/or suction force increases through the free air apertures 330. This is shown by flow indicators 333, and is due to reduced permeability of the back wall 306 (e.g., as a result of debris accumulated thereon).

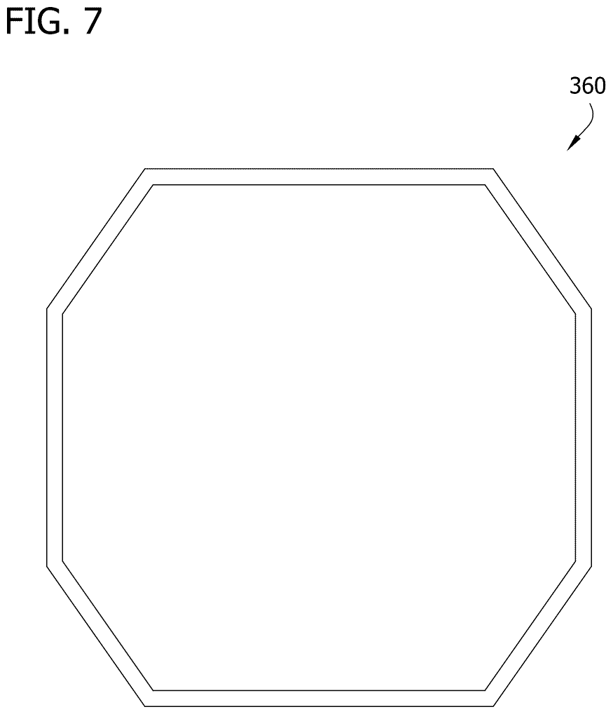

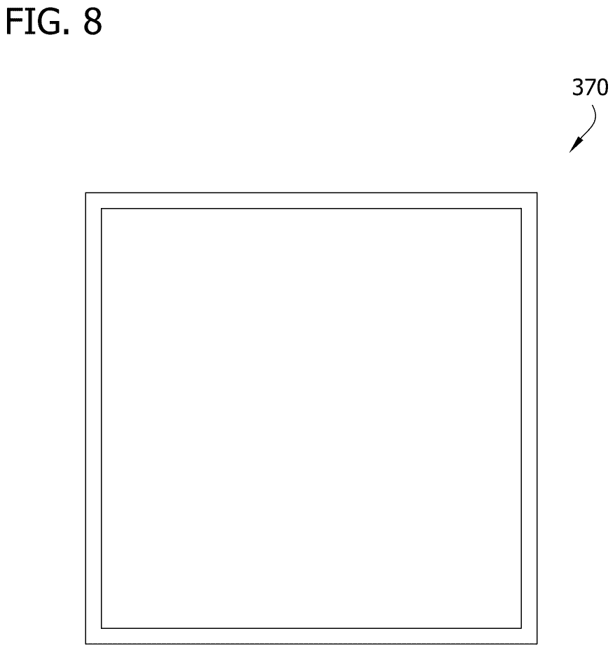

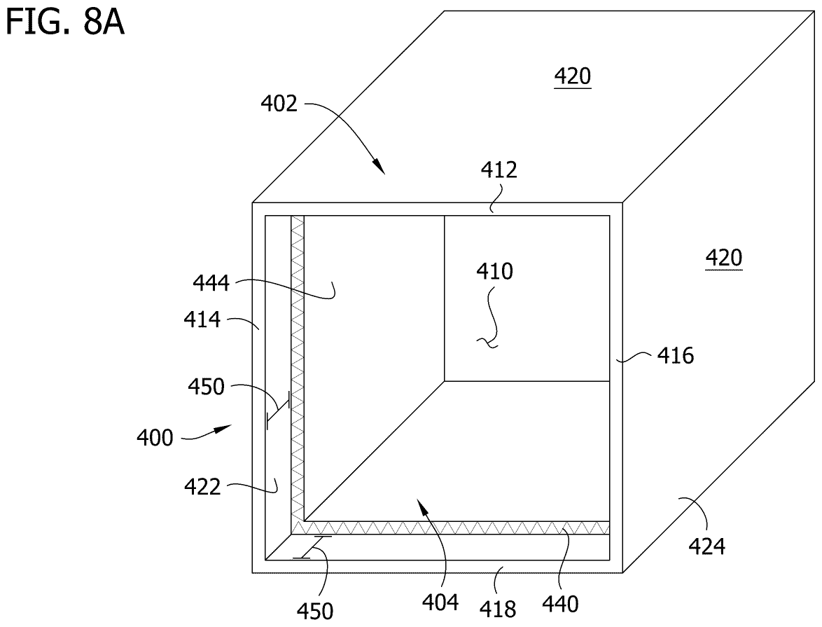

FIGS. 7 and 8 show a rear support member 360 and a front support member 370, respectively, for use with the filter 300. In an exemplary embodiment, the rear support member 360 is formed in the shape of an octagon. In such an embodiment, the rear support member 360 is inserted into the filter 300 and against the back wall 306 to support the filter and filter sleeve 202 during use. As described herein, filter media may be folded over the rear support member 360 to form free air apertures 330 when positioned in the filter sleeve 202 and/or the housing 201. Alternatively, the back wall 306 may be formed to fit against the rear support member 360 such that a securement member 332 is unnecessary. In such an embodiment, the back wall 306 is fabricated (e.g., cut) into substantially the same shape as rear support member 360.

The front support member 370 is inserted into the intake or front portion of the filter 300. The front support member 370 is fabricated to provide structural support to the filter 300. In an exemplary embodiment, the front support member 370 is shaped and sized to be inserted into the housing 201 and in contact with the front face of the filter sleeve 202 (e.g., as shown in FIG. 8). In such an embodiment, the filter sleeve 202 prevents the filter 300 from being pulled into the duct 114 and/or the ventilation system 104 by the pressure or suction provided by the motor or blower 112 (e.g., as shown in FIG. 1).

The rear and front support members 360, 370 may be secured in the filter 300 by any means for securement (e.g., clamps, glue, tape, staples, sewing, ultrasonic welding, stoppers, bands, nails, screws, tie-downs, etc.). In an exemplary embodiment, the rear support member 360 is manufactured and/or formed having an octagon geometry to create four free air apertures 330 and the front support member 370 is manufactured and/or formed having a square geometry. The rear support member 360 may be formed in such a manner as to create any number of free air apertures 330 (1 free air aperture, 2 free air apertures, 3 free air apertures, 5 free air apertures, 6 free air apertures, 7 free air apertures, 8 free air apertures, 9 free air apertures, 10 free air apertures, etc.). Accordingly, the rear and front support members 360, 370 may be formed to have any shape (e.g., an oval shape, a circle shape, a square shape, a rectangle shape, an octagon shape, a hexagon shape, etc.)

In an exemplary embodiment, the rear and front support members 360, 370 are fabricated from metal. Alternatively, the rear support member 360 can be manufactured from any material that provides rigidity to the filter 300 and/or the filter sleeve 202 (e.g., cardboard, metal, hemp, mycelium, carbon, plastic, carbon fiber, bioplastics, PLA (Polylactic acid), PBAT (polybutylene adipate terephthalate), PET (polyethylene terephthalate), HDPE (high-density polyethylene), LDPE (low-density polyethylene), PE (polyethylene), seaweed, cornstarch, plant material, etc.). In an exemplary embodiment, the rear support member 360 is positioned within the filter 300. In some embodiments, the rear support member 360 is positioned on the exterior of the filter 300 adjacent the back wall 306. In yet another embodiment, the rear support member 360 is integrated into the filter media to form the back wall 306 of the filter 300. In the exemplary embodiment, the rear and front support members 360, 370 are formed to enable the filter 300 to be held within the filter sleeve 202 by a friction fit. Alternatively, the filter 300 can be positioned within the filter sleeve 202 and held in place by any means that facilitates retention while enabling the filter to trap particulates (e.g., clamps, glue, tape, staples, sewing, ultrasonic welding, stoppers, bands, nails, screws, tie-downs, etc.). As described herein, the rear and front support members 360, 370 can each be positioned on the interior of the media of the filter 300, the exterior of the media of the filter, or integrated into the media of filter.

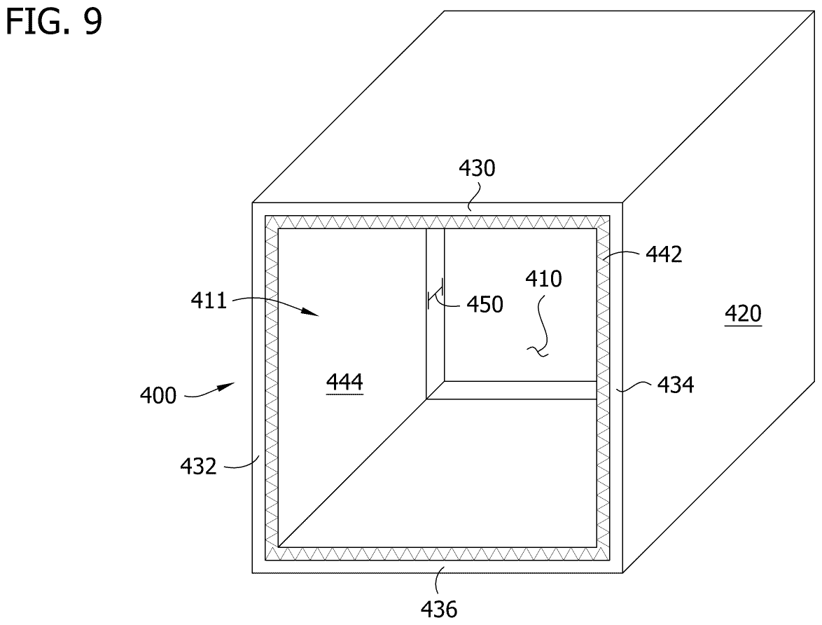

FIGS. 8A and 9 show front and rear perspective views, respectively, of a filter assembly 400 (shown as filter assembly 200 in FIG. 2). The filter assembly 400 includes a housing 402 and a sleeve 404 configured to be inserted into the housing. The housing 402 includes a front aperture 410 formed by a front top face 412, a first front side face 414, a second front side face 416, and a front bottom face 418. Sidewalls 420 extend from the faces of the front aperture 410 to a back aperture 411. The back aperture 411 is formed by a top back face 430, a first back side face 432, a second back side face 434, and a bottom back side face 436. Each of the sidewalls include an inner face 422 and outer face 424.

The sleeve 404 includes a front face 440 and a rear face 442 formed by sidewalls 444 extending therebetween. In an exemplary embodiment, the sleeve 404 is configured to be mounted or positioned within the housing 401, such that the rear face 442 is substantially flush with the back faces 430, 432, 434, 436. In such an embodiment, the front face 440 is spaced a distance 450 from the first faces 410, 412, 414, 416. In an exemplary embodiment, the distance 450 is 1.5 inches. In some embodiments, the distance 450 is in the range of 0.1 inches to 5.0 inches. Alternatively, the distance 450 may be any distance that enables filtration through the assembly 400. As described herein, the front face 440 is configured to contact or support the front support member 370 (e.g., as shown in FIG. 7) or filter media surrounding the front support member to prevent the filter 300 from being pulled into the duct 114 and/or the ventilation system 104 by pressure or suction provided by the motor or blower 112 (e.g., as shown in FIG. 1).

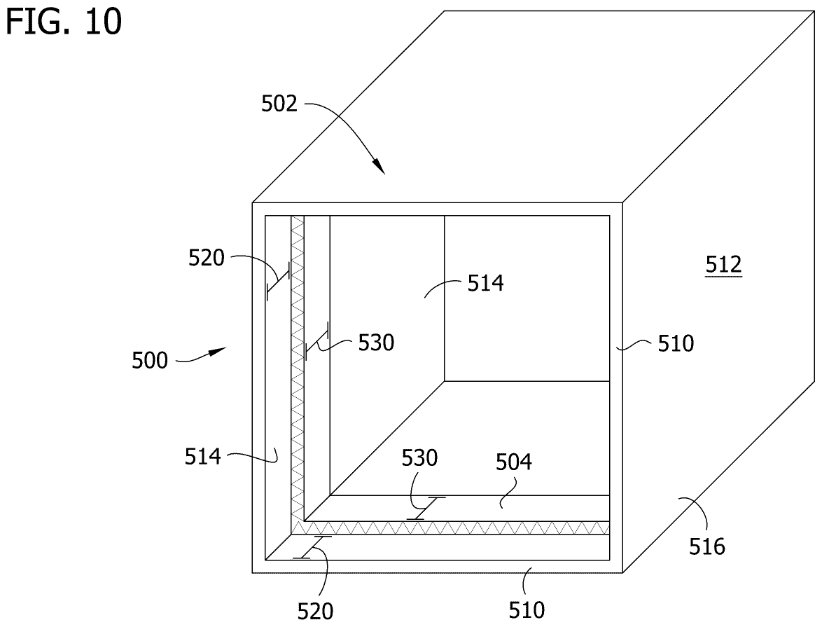

FIG. 10 shows an alternative filter assembly 500 compatible with the system 100 (e.g., as shown in FIG. 1). In the exemplary embodiment, the filter assembly 500 includes a housing 502 and a retention member 504 coupled to the housing. The housing 502 includes a front aperture formed by a front face 510. Sidewalls 512 extend from the front face 510 to the rear face. Each of the sidewalls 512 include an inner face 514 and an outer face 516. In an exemplary embodiment, a retention member 504 is coupled to the inner face 514 of the sidewalls 512. In the exemplary embodiment, the retention member 504 is spaced apart a distance 520 from the front face 510. The distance 520 is 1.5 inches. In some embodiments, the distance 520 is in the range of 0.1 inches to 5.0 inches. Alternatively, the distance 520 may be any distance that enables filtration through the filter assembly 500. While the exemplary embodiment is shown having one retention member 504 within the housing 502, it should be noted that any number of retention members may be utilized in the housing (e.g., 1 retention member, 2 retention members, 3 retention members, 4 retention members, 5 retention members, 6 retention members, 7 retention members, 8 retention members, etc.). As such, the retention member(s) 504 may be spaced with different distances 520 from the font face 510.

The retention member 504 can be coupled to the inner face 514 by any securement means that facilitate retention of a filter within housing 502 (e.g., clamps, glue, taps, staples, sewing, ultrasonic welding, bands, nails, screws, tie-downs, etc.). In an exemplary embodiment, the retention member 504 has a length 530 of 2 inches. In some embodiments, the retention member 504 has a length 530 in the range of 0.1 inches to 4.0 inches. Alternatively, the retention member 504 may have any length 530 that facilitates retention of the filters 300 as described herein. It should be noted that use of the retention member 504 eliminates the need for an inner sleeve in a filter assembly while still preventing the filter 300 from being pulled into the duct 114 and/or the ventilation system 104 by pressure or suction provided by the motor or blower 112 (e.g., as shown at FIG. 1).

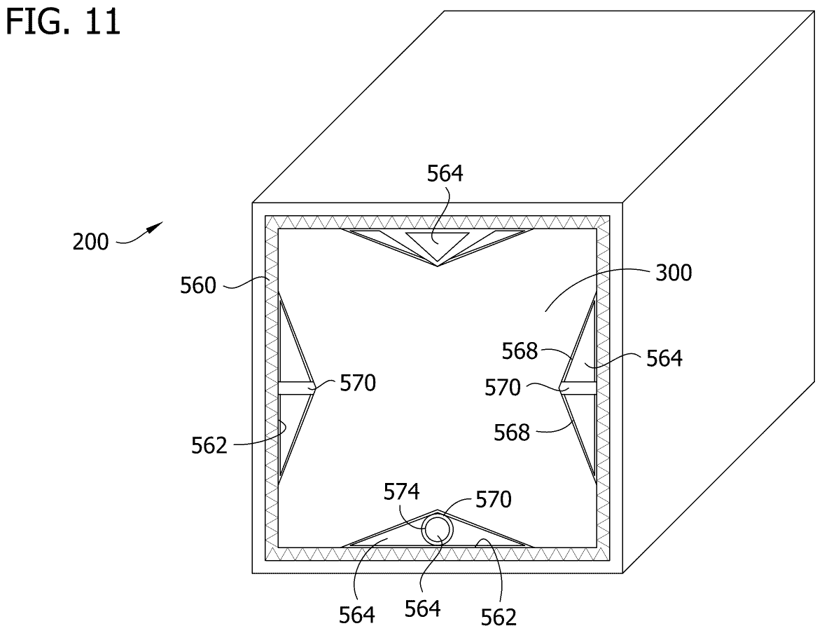

FIG. 11. shows the filter assembly 200 including an alternative sleeve 560. In an exemplary embodiment, the sleeve 560 is coupled to airflow support members 562. In such an embodiment, the airflow support members 562 are configured (e.g., fabricated) to create airflow pockets or apertures 564 between the filter 300 and the sleeve 560. The airflow support members 562 enable the filter assembly 200 to achieve airflow when the back wall of the filter 300 is clogged by particulates (e.g., when the filter has a reduced permeability). The airflow support members 562 function as an alternative to rear support member 360 to form the filter 300 into a shape defined by the rear support member. As such, in one embodiment, the filter 300 is a box filter and the airflow support members 562 force portions of filter away from the sidewalls of the sleeve 560 to form apertures 564. In the exemplary embodiment, the airflow support members 562 include a base 566 and support arms 568 extending therefrom to form the apertures 564. In some embodiments, the airflow support members 562 include a spar 570 positioned in the apertures 564 to provide added structural support to the airflow support members to accommodate the weight of particulate accumulation on the back wall of filter 300 during operation.

In an exemplary embodiment, the airflow support members 562 are coupled to the inner face of the sidewalls of the sleeve 560. Alternatively, the airflow support members 562 can be formed by cutting portions of the sidewall to enable arms 568 to fold against each other and be coupled together to form the airflow support members. In such an embodiment, a base 566 and the arms 568 are integrally formed by the sleeve 560. It should be noted that in the illustrations provided herein, the airflow support members 562 are formed to substantially create a triangle, however, they can be formed to have any shape (e.g., an oval shape, a circle shape, a square shape, a rectangle shape, an octagon shape, a hexagon shape, etc.). Any number of airflow support members 562 can be utilized within the sleeve 560 to form the apertures 564 (e.g., 1 airflow support member, 2 airflow support members, 3 airflow support members, 4 airflow support members, 5 airflow support members, 6 airflow support members, 7 airflow support members, 8 airflow support members, 9 airflow support members, 10 airflow support members, etc.). Additionally, the airflow support members 562 can be positioned at any location on or within the sleeve 560 that facilitates creating airflow throw the assembly 200 as particulates accumulate in or on the filter 300. The airflow support members 562 can be coupled within the sleeve 560, and the arms 568 may be coupled together by any coupling means (e.g., clamps, glue, tape, staples, sewing, ultrasonic welding, stoppers, bands, nails, screws, tie-downs, etc.). The airflow support members 562 can include any number of spars 570 to support the filter 300 (e.g., 1 spar, 2 spars, 3 spars, 4 spars, 5 spars, 6 spars, 7 spars, 8 spars, 9 spars, 10 spars, etc.). Additionally, the spars 570 can be fabricated in any shape that facilitates support of the filter 300, including a rectangle 572, an oval 574, a circle, a square, a rectangle, an octagon, a hexagon, or any other shape or combination thereof. The airflow support members 562 can be manufactured from any material (e.g., cardboard, metal, hemp, mycelium, carbon, plastic, carbon fiber, bioplastics, PLA (Polylactic acid), PBAT (polybutylene adipate terephthalate), PET (polyethylene terephthalate), HDPE (high-density polyethylene), LDPE (low-density polyethylene), PE (polyethylene), seaweed, cornstarch, plant material, etc.).

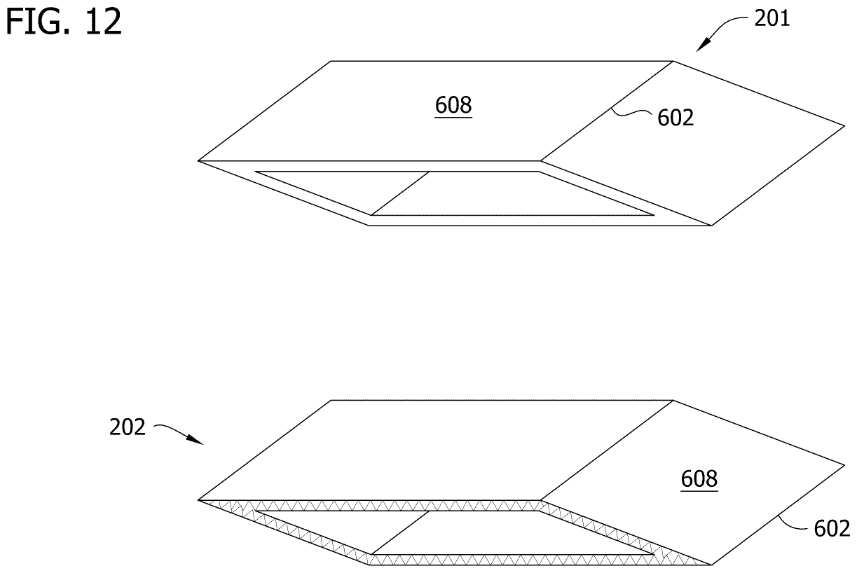

FIG. 12 shows the housing 201 and the filter sleeve 202 configured for use in the assembly 200 (e.g., as shown in FIG. 2) in a semi collapsed form. In the exemplary embodiment, the housing 201 and the sleeve 202 include flexible seams 602 at the intersection of the sidewalls 608. The flexible seams 602 enable the housing 201 and the sleeve 202 to collapse, providing ease of shipping and disposal. In some embodiments, the side walls 608 are manufactured from a semi-rigid or rigid material, and the seams 602 are manufactured from a different semi-flexible or flexible material (e.g., different from the material of the side walls). In one embodiment, the sidewalls 608 are individual components coupled together with hinges which form the seams 602. In some embodiments, the housing 201 and the sleeve 202 are fabricated as a unitary piece, such as by a mold. Alternatively, the housing 201 and the sleeve 202 may be manufactured as a long piece of material with cuts or incisions formed in the sidewalls 608. The cuts or incisions define the seams 602, and enable the housing 201 and the sleeve 202 to be formed by coupling two edges together to form the seam 602.

In an exemplary embodiment, the housing 201 and the sleeve 202 are fabricated from plastic, however the housing and the sleeve may be manufactured from any material that provides support to the filter 300 (e.g., cardboard, metal, hemp, mycelium, carbon, plastic, carbon fiber, bioplastics, PLA (Polylactic acid), PBAT (polybutylene adipate terephthalate), PET (polyethylene terephthalate), HDPE (high-density polyethylene), LDPE (low-density polyethylene), PE (polyethylene), seaweed, cornstarch, plant material, etc.). When the housing 201 and the sleeve 202 are fabricated from plastic or a combination of alternative materials, the sleeve can be reused multiple times. This feature reduces both cost and environmental impact. Additionally, fabrication of the housing 201 and the sleeve 202 from plastic prevents wood or cardboard fibers from being released into the air, as is a common drawback of cardboard options (e.g., legacy filters). Often, these wood or cardboard fibers deposit on parts being painted (e.g., the object 110 of FIG. 1), resulting in expensive rework and/or ruined product. In some embodiments, the material in the housing 201 and the sleeve 202 is corrugated. In some embodiments, the airflow support members 562 are coupled directly to the inner walls of the housing 201 to eliminate the need for the sleeve 202. In such embodiments, the retention members 504 can be utilized to maintain the filter 300 within the housing 201.

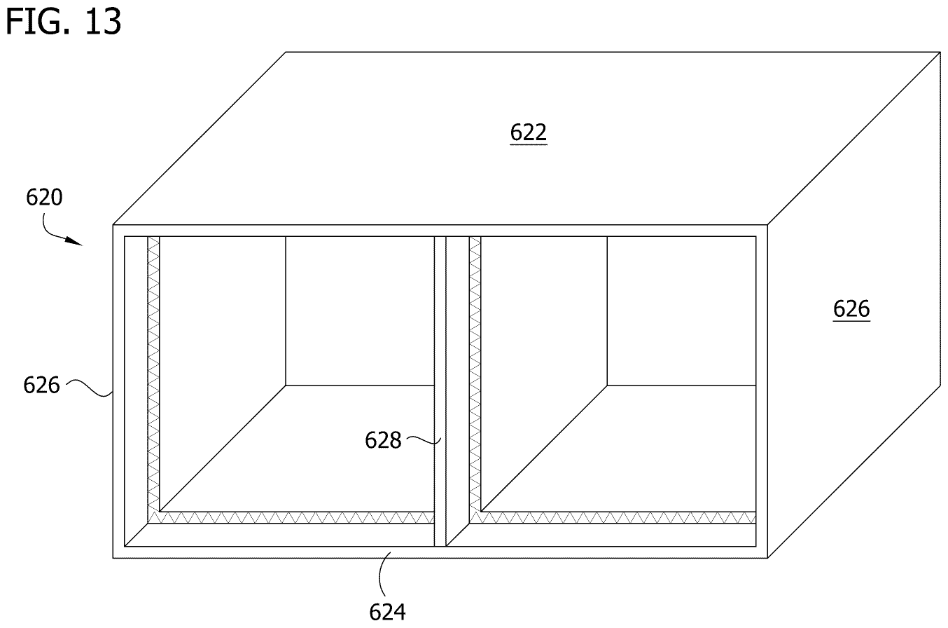

FIG. 13 shows an alternative housing 620 (e.g., for use within the system 100 of FIG. 1). The housing 620 includes a top wall 622, a bottom wall 624, and sidewalls 626. A divider 628 is positioned in the middle of the top wall 622 and the bottom wall 624, and extends therebetween. In an exemplary embodiment, the housing 620 is shaped and sized to receive and retain two filter sleeves 202 and two filters 300 therein. Alternatively, the housing 620 may be shaped and sized to receive and retain retention members 504, two filters 300, and/or on or more support members 562, eliminating the need for the filter sleeves 202. In some embodiments, filter assemblies 200 and 400, including housings 201 and 620, are manufactured to be slidably inserted and removed from the filter assemblies 101 within system 100.

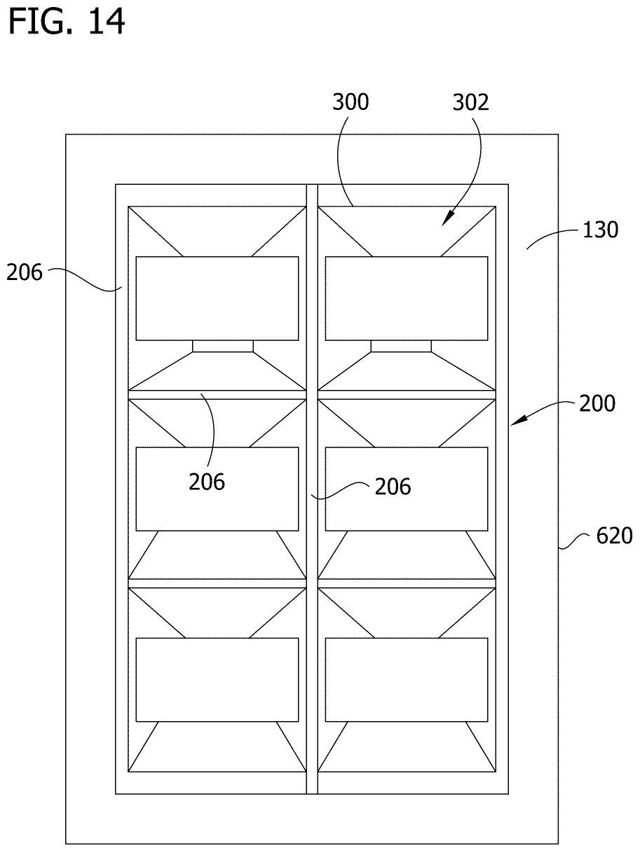

FIG. 14 shows multiple filter assemblies 200 inserted into the mobile unit 130 of FIG. 1. The filter assemblies 200 include a housing 620 and retention members 206, maintaining the filters 300 within the filter assembly 101. In the exemplary embodiment, the filters 300 include a front baffle extending across a portion of front side 302.

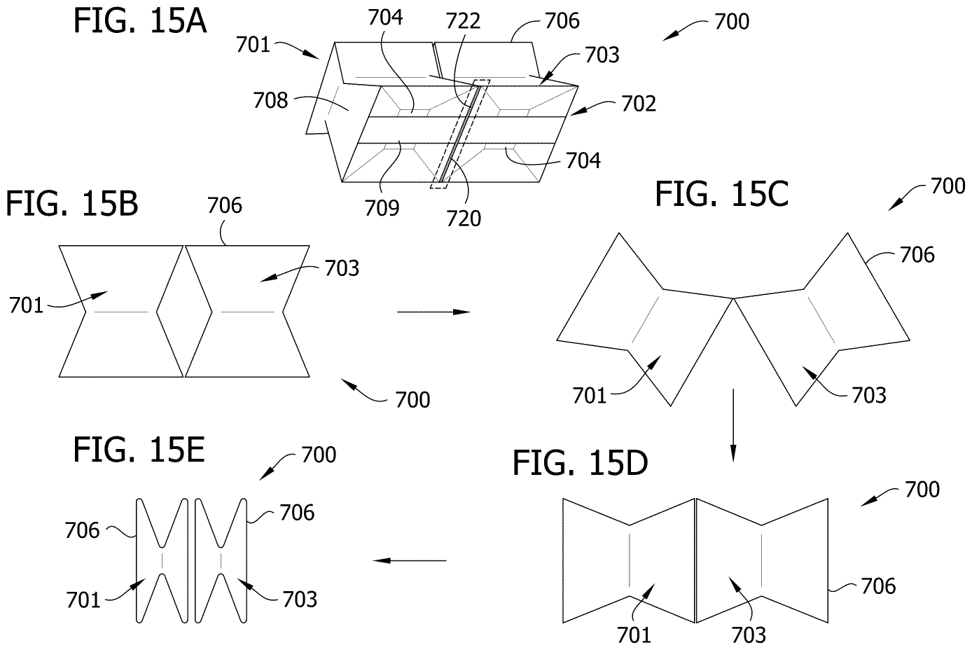

FIGS. 15A-15E show a filter array 700 which is suitable for use with the housing 620 of FIG. 13. FIG. 15A is a front perspective view of the filter array 700, and FIGS. 15B-15E are top views of the filter array in different configurations. In an exemplary embodiment, the filter array 700 is formed from filter media, and includes a first filter 701 and a second filter 703. Each of the filters 701, 703 include a body having a front side 702 (i.e., an upstream side) defining a first aperture 704, a back wall 706 (i.e., a downstream wall) at an opposite longitudinal end of the filter, and at least one side wall 708 extending between the front side and the back wall 706. Together, the front side 702, back wall 706, and at least one side wall 708 define a filter plenum 709 through which the flowable substance to be filtered flows.

In an exemplary embodiment, the filters 701, 703 are secured together along a folding section 720. In one embodiment, the filter array 700 is formed from a single piece of filter media. In such an embodiment, filter media is cut and secured together to form desired shapes of the filters 701, 703. In one embodiment, the filters 701, 703 are formed separately and subsequently coupled together along the folding section 720. A securement member 722 is utilized such that the edges of the filters 701, 703 are configured to couple to the securement member 722 and thereby join the filters together. The securement member 722 can be fabricated from any bendable or flexible material (e.g., polyester, thermal or resin bonded polyester, polypropylene, polyurethane, polyethylene, polyethylene foam, polyurethane foam, polyphenylene sulfide, polyolefin plastic, coal, glass, micro glass, spun glass, animal hair, organic fiber, fiberglass, acrylic fiber, paper, paper poly, cotton, nylon, Teflon, Aramid, felt, metal, fiber blend, wood, plastic, cardboard, etc.). In some embodiments, the filters 701, 703 are directly joined along the folding section 720. The filters 701, 703 may be coupled to the securement member 722 or to each other using any securement means that allows filters to bend or flex along the folding section 720 (e.g., clamps, glue, tape, staples, sewing, ultrasonic welding, stoppers, bands, nails, screws, tie-downs, etc.).

FIGS. 15B-15E illustrate the filter array 700 being folded or collapsed to enable ease of storage and/or shipping thereof. As illustrated, the filters 701, 703 remain flexibly coupled. Additionally, the back wall 706 can be pushed towards the front side 702 to create a collapsed filter array 700.

Referring generally to FIGS. 8A-15D, the filter array 700 is formed to mimic two filters 300 positioned side by side with the added benefit of being coupled or secured together. Such an array enables the housing 620 to be effective in operation without the divider 628. In the exemplary embodiment, the filters 701, 703 are fabricated to include the apertures 330 when inserted into the filter sleeve 202. While the filter array 700 is shown as a linear array formed by two filters, any number of filters can be formed together in a linear fashion (e.g., 3 filters, 4 filters, 5 filters, 6 filters, 7 filters, 8 filters, 9 filters, 10 filters, etc.). In some embodiments, the filter array 700 is formed in a matrix fashion such as 2× 2 (i.e., a matrix having two columns and two rows). As such, the matrix of the filter array 700 may be formed to have a square shape (e.g., 2×2, 4×4, n×n, etc.) or a rectangle shape (e.g., 2×3, 3×4, n×m wherein n/m, etc.). The filter array 700 can have any number of filters coupled together in a matrix which facilitates filtration as described herein (e.g., 3 filters, 4 filters, 5 filters, 6 filters, 7 filters, 8 filters, 9 filters, 10 filters, 11 filters, 12 filters, etc.). In one embodiment, filters coupled in the filter array 700 are semi-rigidly or rigidly coupled together to prevent movement of filters within the filter array and to provide support during filtration.

In an exemplary embodiment, the first and second filters 701, 703 are formed of the same filter media. In an alternative embodiment, the first filter 701 is fabricated from a first filter media and the second filter 703 is fabricated from a second filter media which is different from the first filter media. Likewise, when arranged in a matrix, each filter 701, 703 of the filter array 700 may be fabricated from the same filter media or from a different filter media than other filters within the array.

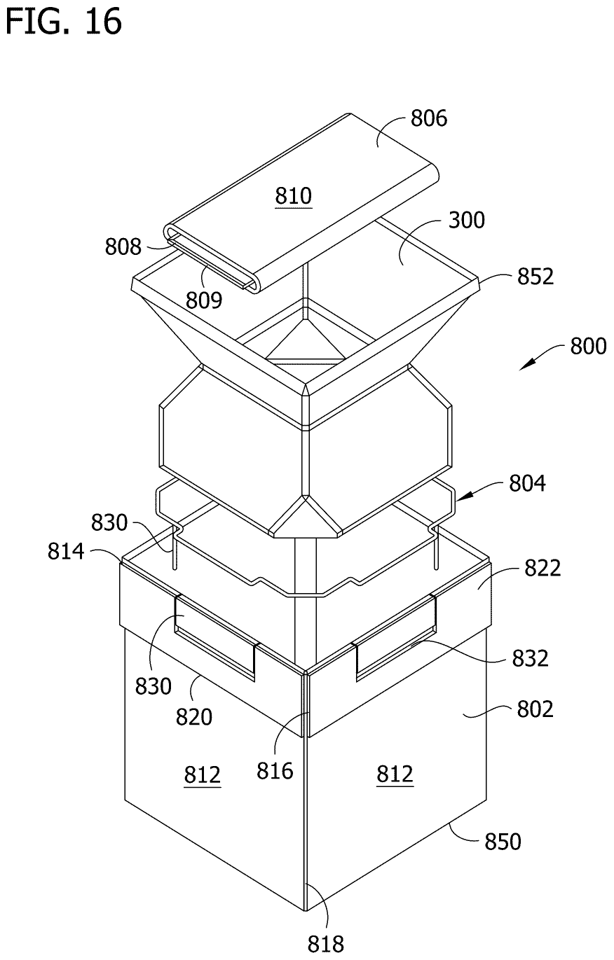

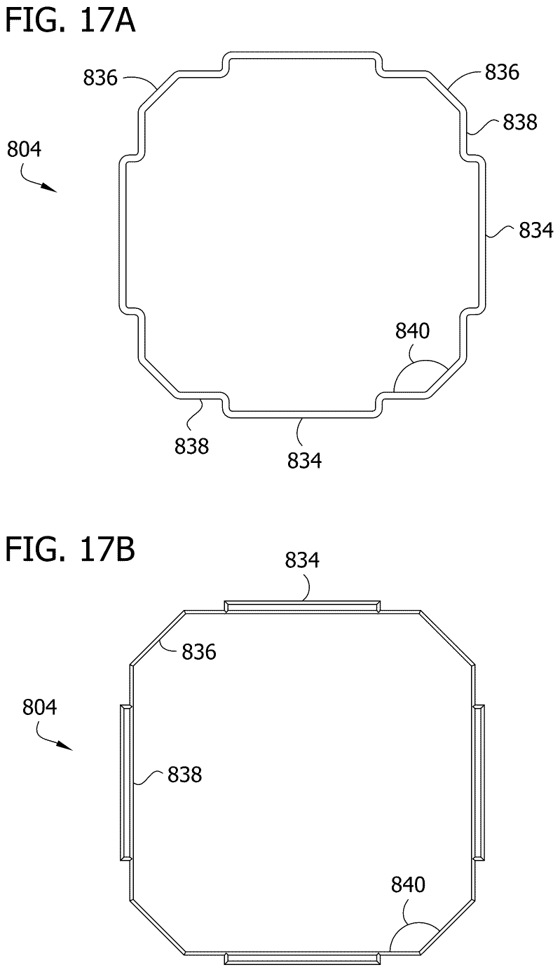

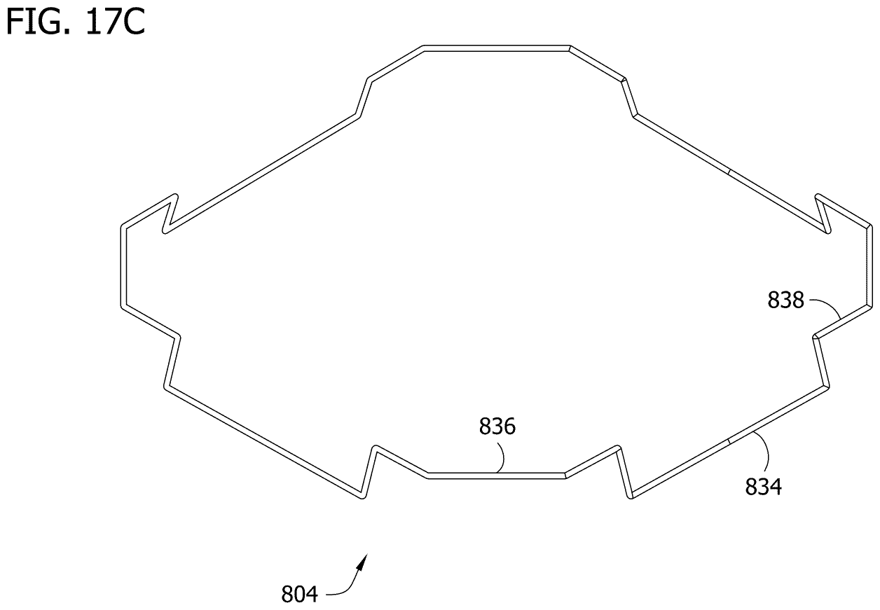

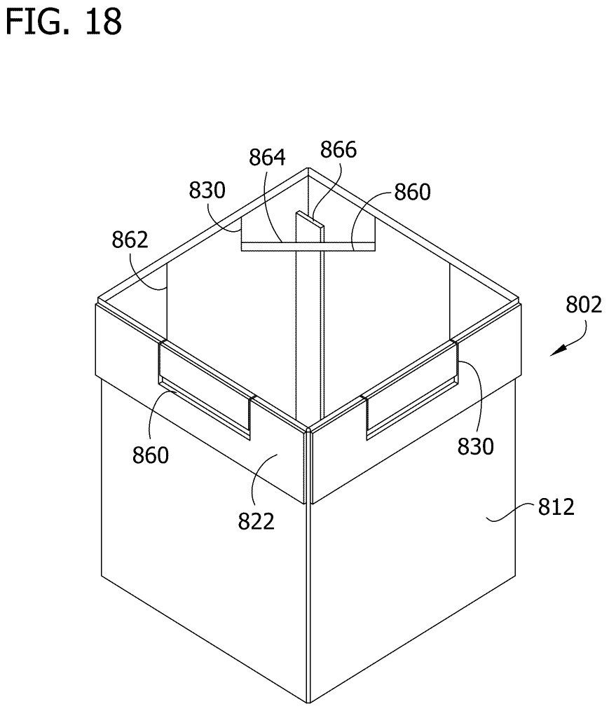

FIG. 16 shows an alternative filter assembly 800 which is compatible with system 100 of FIG. 1. In an exemplary embodiment, the filter assembly 800 includes a filter sleeve 802, a retention member or ledge frame 804, and the filter 300. FIGS. 17A, 17B, and 17C show ledge frames 804 for use with the filter assembly 800. In some embodiments, the filter assembly 800 includes a filter baffle 806. In such an embodiment, the filter baffle 806 includes a baffle frame 808 surrounded by filter media 810.

Referring to FIGS. 16-17C, the filter sleeve 802 is fabricated having four sidewalls 812 configured to accept and retain the filter 300 and the ledge frame 804. The filter sleeve 802 is formed with horizontal scores 814 partially within, and not through, the sidewalls 812. The filter sleeve 802 further includes cuts 816 through the corner edges 818 extending from a top edge 820 to the horizontal scores 814. In the exemplary embodiment, the cuts 816 are provided in the filter sleeve 802 to enable the top edge 820 to fold down onto the sidewall 812 to form a flap 822. In some embodiments, the flap 822 is secured against the sidewall 812 by heat bonding. Alternatively, the flap 822 can be secured to sidewall in any method (e.g., stitching, gluing, staking, heat staking, ultrasonic welding, pinning, stapling, etc.).

In the exemplary embodiment, the filter sleeve 802 includes ledge slots 830 which extend downwardly along the sidewall 812 and the flap 822 from the score 814. In some embodiments, the slots 830 are in the range of 0.2 inches to 6.0 inches. Additionally, the slots 830 are fabricated with a width which enables the ledge frame 804 to be removably positioned through a portion of the filter sleeve 802. In one embodiment, the flap 822 is fabricated with an aperture 832 extending between the slots 830. The aperture 832 enables a portion of the ledge frame 804 (e.g., the edge 834) to be positioned on the exterior portion of the filter sleeve 804, but not to extend outwardly past the flap 822 to enable the filter sleeve to be slidably positioned in a housing of the system 100 and/or the mobile unit 130.

Although the flap 822 may be fabricated to any dimension that facilitates securement and retention of the frames 804, 806, in one embodiment, the flap has a length which extends from the score 814 to the edge 820. In such an embodiment, the flap 822 has a length which extends from the edge 820 to the aperture 832 which is 5 inches.

Referring to the embodiment of FIG. 17A, the ledge frame 804 is a tetraicosagon (i.e., a 24 sided polygon) configured to retain the filter 300 within the filter sleeve 802 while in operation. The frame 804 includes outer edges 834 configured to be positioned on the exterior of the sidewalls 812. The frame 804 further includes angle filter support edges 836 configured to be positioned on the interior of the sidewalls 812, as well as interior support bars 838 which extend filter support edges 836 to form an angle 840. In one embodiment, the angle 840 is 135°. Alternatively, the angle 840 can be any angle that facilitates support of filters with the filter sleeve 802, including, but not limited to, angles in the range of 85° to 179°. In the exemplary embodiment, the frame 804 is fabricated in the range of 0000 gauge to 30 gauge or 0.46 inch (11.684 mm) diameter to 0.01 inch (0.255 mm) diameter. In one embodiment, the frame 804 is fabricated with a diameter of approximately 0.144 inches (e.g., nine gauge). FIG. 17B shows an alternative embodiment of the frame 804 in which support bars fully extend between the support edges 836. Such an embodiment provides added support and reinforcement to the outer edges 834.

FIG. 17C shows an alternative frame 804 which is compatible with the filter sleeve 802. In such an embodiment, the frame 804 is configured to rest on a top edge of the sidewalls 812, and bend down to enable the filter to be positioned within the filter sleeve 802. As such, the frame 804 enables the filter sleeve 802 to be fabricated without slots 830.

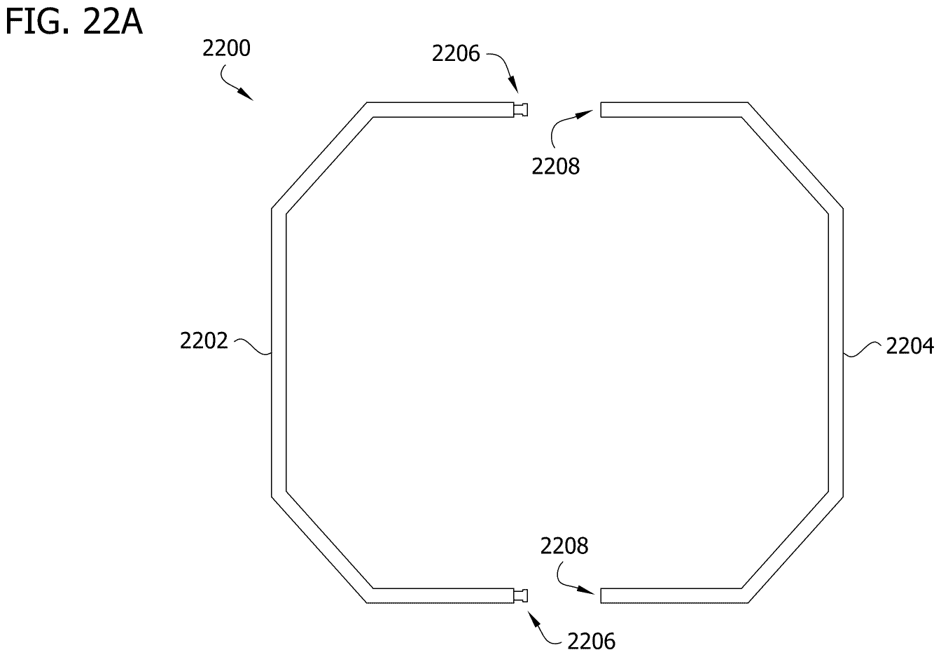

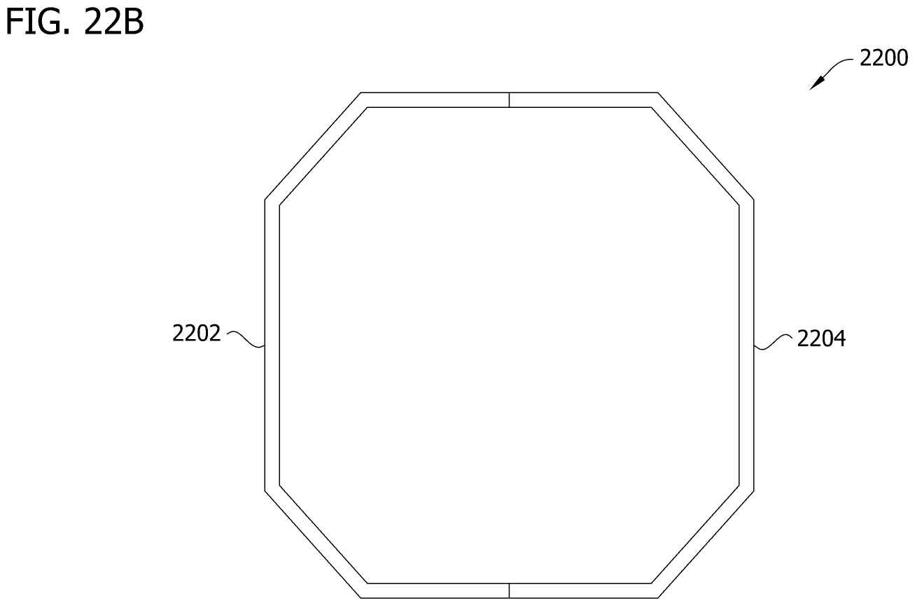

The frame 804 may be provided as a multi-piece assembly configured to be assembled using connectors. For example, referring briefly to FIGS. 22A-B, in an exemplary embodiment, a multi-piece frame 2200 is provided as a two-part assembly having a first frame piece 2202 and a second frame piece 2204 of substantially the same size and dimension. FIG. 22A shows the multi-piece frame in a separated configuration, while FIG. 22B shows the multi-piece frame in a unified (e.g., combined) configuration. Each of the frame pieces 2202, 2204 include a portion or portions of a connector at ends thereof. In one embodiment, the connectors are barb-style connectors with a male portion and a female portion configured to releasably mate, such that the frame pieces 2202, 2204 are combinable to form the multi-piece frame 2200. In the illustrated embodiment, the first frame piece 2202 includes male connector portions 2206 (e.g., hooks or barbs) at each of two ends of the first frame piece, and the second frame piece 2204 includes female connector portions 2208 (e.g., openings configured to releasably receive and retain the hooks or barbs) at each of two end regions of the second frame piece. Because the multi-piece frame 2200 is configured to be assembled from two or more separate frame pieces, it can be transported (e.g., shipped) more easily and efficiently (e.g., in packages with a reduced dimension). The multi-piece frame 2200 is fabricated from an incinerable (e.g., combustible, burnable) material, such that the material is configured to be destroyed in the event that it is burned (e.g., after use). Other components of the present disclosure may be similarly constructed (e.g., as a multi-piece assembly, from incinerable materials) for improved performance and reduced cost. While the illustrated embodiment of the multi-piece frame 2200 of FIGS. 22A-B has an octagonal geometry, alternative embodiments of the multi-piece frame may have other shapes (e.g., rectangular).

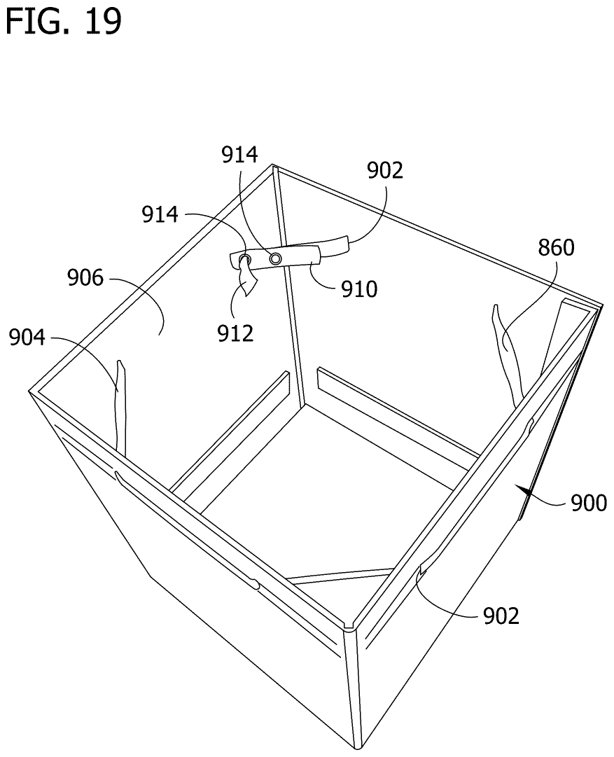

FIG. 18 shows the filter sleeve 802 utilizing an alternative filter retention member 860 (e.g., a ledge frame). In the exemplary embodiment, the filter retention member 860 is a flexible strap positionable through and within the slots 830. When positioned in the filter sleeve 802 through the slots 830, the filter retention member 860 forms an angle 862 with respect to the inner surface of the sidewalls 812 which is generally (e.g., approximately) a 45° angle. It should be noted that the angle 862 can be any angle that retains filters within the filter sleeve 802 during operation. In one embodiment, the filter retention member 860 is formed from polyester, however it may be fabricated from any material described herein. In some embodiments, the filter retention member 860 is fabricated with a width in the range of 0.05 inches to 4.00 inches. In a preferred embodiment, the width is 0.50 inches. In some embodiments, the filter retention member 860 is inserted into the slots 830 and substantially secured within the filter sleeve 802 when the flap 822 is secured against the sidewall 812. Alternatively, the filter retention member 860 can be removably inserted into the filter sleeve 802 and the slots 830.

FIG. 19 shows an alternative sleeve 900 utilizing the filter retention member 860. In the exemplary embodiment, to aid in the simplification of manufacturing, the sleeve 900 includes a plurality of slots or apertures 902 which facilitate insertion of the filter retention member 860 therethrough. When positioned in the sleeve 900 through the slots 902, the filter retention member 860 forms a generally (e.g., approximately) 45° angle 904 with respect to the inner surface of sidewalls 906. It should be noted that the angle 904 can be any angle that retains filters within the sleeve 900 during operation. In one embodiment, the filter retention member 860 is formed (e.g., fabricated) from polyester, however it may be formed from any material described herein. In some embodiments, the filter retention member 860 is formed with a width in the range of 0.05 inches to 4.00 inches. In a preferred embodiment, the filter retention width is 0.50 inches.

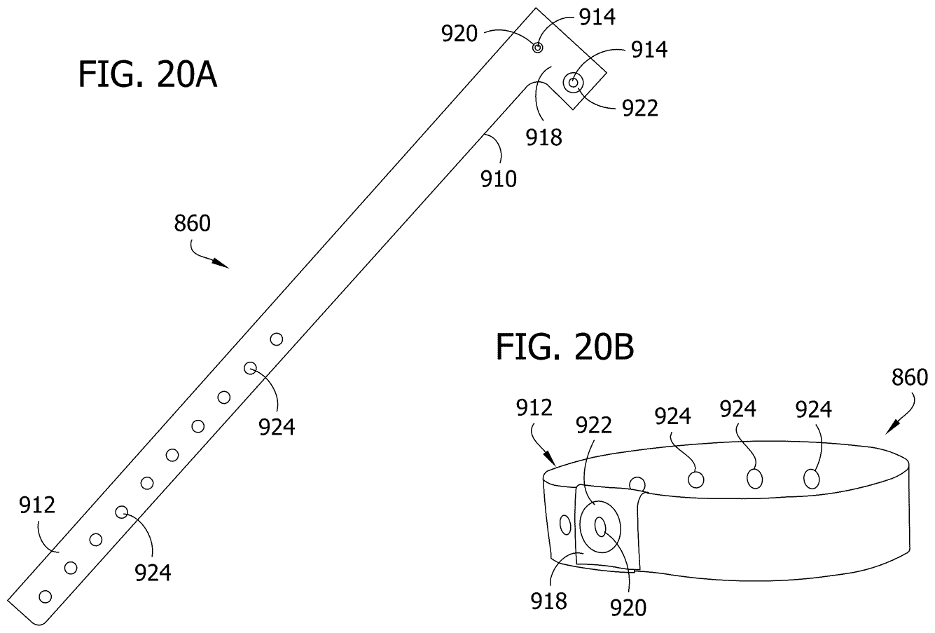

Referring to FIGS. 20A and 20B, the filter retention member 860 includes a first end 910 and a second end 912 which are couplable together via one or more coupling members 914 to secure the filter retention member with respect to the filter sleeve 802 and/or the sleeve 902. In the exemplary embodiment, the coupling members 914 are self-securing or self-locking snaps. In some embodiments, the self-securing snaps include a male portion and a female portion, such that the male portion is secured to the first end 910 and the female portion is secured to the second end 912. In an alternative embodiment, the coupling members 914 are buttons or projections which secure to the first end 910 and are configured to extend through or into a hole punched in the second end 912. Alternatively, the coupling members 914 can be any securement mechanism for securing the filter retention member 860 to itself (e.g., a standard buckle, roller buckle, side-release buckle, cam buckle, ratchet buckle, snap buckle, ladder lock buckle, carabiner, snap hook, trigger hook, S-hook, D-ring, O-ring, tri-glide slider, button stud, Chicago screw, turn lock, hook-and-loop (Velcro), double-sided tape or adhesive, box-X stitching, overlap sewn ends, bar tack stitching, square knot, bowline knot, slip knot, magnetic clasp, magnetic snap, slip buckle, tensioner clamp, loop-through slot, weaving ends through fasteners, snap fasteners, zipper mechanism, turnbuckle, heat sealing or welding, ultrasonic welding, crimping, elastic loops or bands, lace-up system (eyelets or grommets), pin and hole system, twist-and-lock system, rivets, etc.).

As shown at FIGS. 20A and 20B, the filter retention member 860 includes the first end 910, the second end 912, and the coupling member 914. In some embodiments, the filter retention member 860 includes a retention flap 918 which extends substantially perpendicular to the first end 910. In such an embodiment, the coupling member 914 includes a male protrusion 920 coupled through the first end 910 and a female connector 922 coupled through the flap 918. While the coupling member 914 is shown as being coupled through the filter retention member 860, it should be noted that portions of or all of the coupling member 914 may be secured or affixed to an outer portion of the filter retention member 860 and not through the strap.

The filter retention member 860 further includes a plurality of apertures 924 formed through the second end 912. It should be noted that any number of apertures 924 can be included in the filter retention member 860 (e.g., 1 aperture, 2 apertures, 3 apertures, 4 apertures, 5 apertures, 6 apertures, 7 apertures, 8 apertures, 9 apertures, 10 apertures, etc.). As such, the apertures 924 enable the filter retention member 860 to be utilized for a number of different sized filters and sleeves while enabling the assembly 800 to function as described herein. Alternatively, the filter retention member 860 can be fabricated with a single aperture 924 to provide a substantially fixed size to reduce of user error or confusion. In operation, the filter retention member 860 is weaved through slots in the filter sleeve 802 and/or the sleeve 900, and secured upon itself to create a fixed retention system. As shown in FIG. 20B, the protrusion 920 is positioned through an aperture 924 and the flap 918 is folded over a portion of second end 912 and the female connector 922 is secured onto the protrusion.

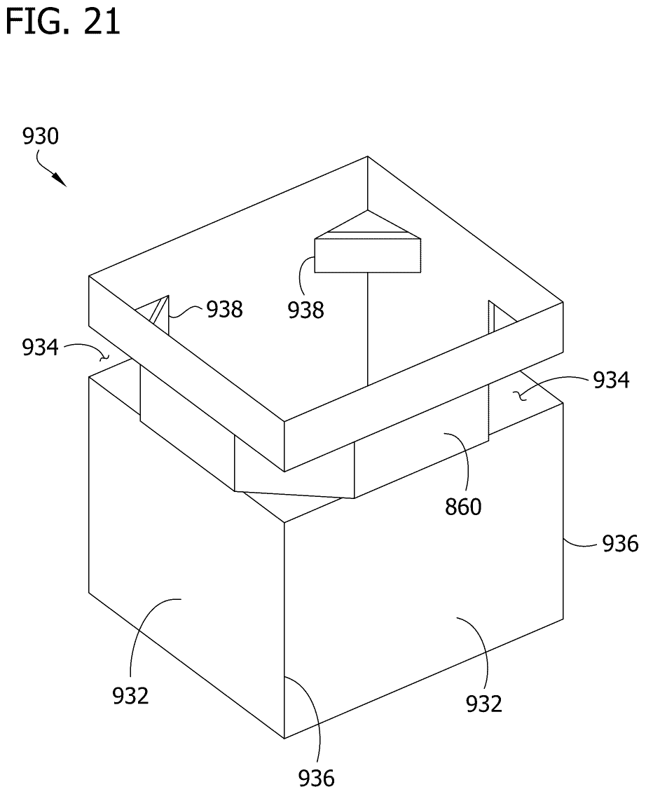

FIG. 21 shows an alternative sleeve 930 compatible with assemblies 200, 400, 500, and/or 800. In such an embodiment, the filter retention member 860 is secured upon itself when wrapped around the outer sidewalls 932 of the sleeve 930. The sleeve 930 includes a plurality of cuts 934 through the sidewalls 932. The cuts 934 extend inwardly from sleeve side edges 936. In one embodiment, a knockout cut 938 is provided between the cuts 934 to define aperture(s) in the sleeve 930. Alternatively, in some embodiments, a portion of the sidewalls 932 is pushed inwardly from the edges 936 when the filter retention member 860 is wrapped around the sleeve 930, providing additional support to filters inserted into the sleeve. In such embodiments, the filter retention member 860 may include one or more coupling members 914 to secure the filter retention member around the sleeve 930. The cuts 934 can be formed within the sleeve 930 at any length that facilitates support of filters as described herein including, but not limited to, lengths in the range of 0.2 inches to 20.0 inches.

In some embodiments, as shown in FIG. 18, the sleeves 802, 900 and/or 930 include one or more retention members 864 coupled to the inner face of the sidewall 812. The retention members 864 include a top edge 866 configured to provide added support to ensure that the filter 300 remains substantially within the sleeves 802, 900 and/or 930 when subjected to a suction force.

Referring to FIGS. 16-18, in the exemplary embodiment, the assembly 800 includes a filter baffle 806 configured to be positioned on top of the filter 300 when in the filter sleeve 802. The frame 808 of the baffle 806 includes an outer edge 809 configured to be positioned against the exterior face of the side wall 812 when placed in the slots 830 of the filter sleeve. In an exemplary embodiment, the frame 808 is a flexible strap fabricated from polyester, and has a width in the range of 0.05 inches to 4.00 inches. In a preferred embodiment, the frame 808 has a width of 0.50 inches. In one embodiment, the frame 808 is fabricated by metal with a diameter of about 0.1144 inches (e.g., nine gauge). Alternatively, the frame 808 can be fabricated from any material described herein having any thickness or width that enables support of the baffle 806 in the assembly 800. In the exemplary embodiment, the filter media 810 is wrapped around the frame 808 and secured to itself by securement methods described herein. In some embodiments, the filter media 810 is also secured to the filter media of filter 300. It should be noted that the filter media of filter 300 and the filter media 810 can be secured together using any method (e.g., stitching, gluing, staking, heat staking, ultrasonic welding, pinning, stapling, etc.). In some embodiments, two filter baffles 806 are positioned in the slots 830 in a perpendicular fashion over the filter 300, forming a cross. It should be noted that the assemblies described herein can utilize any of the front filters or pre-filters described in United States Patent Application 2020/0197850 (FILTRATION ASSEMBLY AND SYSTEM) as filter baffles 806, all of which are herein incorporated by reference.

Although the sleeves 802, 900 and/or 930 can be sized and dimensioned to accommodate any size filter, by way of a non-limiting example, dimensions of an exemplary embodiment of the frame 804 are configured to support a standard 20″×20″ filter, which may have actual dimensions of 18.5″×18.5″. In such an embodiment, the outer edges 834 each have a length of approximately 8.0 inches and the filter support edges 836 each have a length of approximately 4.0 inches. The outer edges 834 are spaced apart with a distance of approximately 19.0 inches between adjacent facing outer edges. Accordingly, the edges 809 are fabricated to have a length of approximately 8.0 inches, and are spaced apart with a distance of approximately 19.0 inches between adjacent facing edges.

Referring generally to FIGS. 1-21 in operation, as a suction force is placed on assembly 200, 400, 500, and/or 800, the filter 300, singly or with the filter baffle 806, is substantially maintained within sleeves 802, 900 and/or 930 by the ledge frame 804 or filter baffle 806 and/or top edge 866. While the filter 300 may be pulled towards a bottom or rear portion 850 of sleeve 802, the filter support edges 836 of the frame 804 or filter baffle 806 maintain the filter within sleeves 802, 900 and/or 930 by contacting and providing as stop or support to corners 852 of the filter.

Filters 300 and 700 are used within assemblies 200, 400, 500, and/or 800, and can have any filter shape that provides filtration of particulates, including the filters provided in United States Patent Application 2020/0197850 (FILTRATION ASSEMBLY AND SYSTEM), the entirety of which is herein incorporated by reference. As such, the filters described herein are designed to be sized in different filter systems with different dimensions and as such, filters 300 and 700 can have any size that facilitates filtration described herein including, but not limited to, 10″×20″ (25.4 cm×50.8 cm), 12″×12″ (30.5 cm×30.5 cm), 12″×20″ (30.5 cm×50.8 cm), 12″×24″ (30.5 cm×61.0 cm), 14″×14″ (35.6 cm×35.6 cm), 14″×20″ (35.6 cm×50.8 cm), 14″×24″ (35.6 cm×61.0 cm), 14″×25″ (35.6 cm×63.5 cm), 15″×20″ (38.1 cm×50.8 cm), 16″×20″ (40.6 cm×50.8 cm), 16″×25″ (40.6 cm×63.5 cm), 18″×20″ (45.7 cm×50.8 cm), 18.5″×18.5″ (46.99 cm×49.99 cm), 18″×24″ (45.72 cm×61.0 cm), 20″×20″ (50.8 cm×50.8 cm), 20″×25″ (50.8 cm×63.5 cm), 20″×30″ (50.8 cm×76.2 cm), and 24″×24″ (61.0 cm×61.0 cm). It should be noted that the structure of the filters described therein are incorporated herein in all aspects, except for the back wall of the filter, which is meant to include at least one aperture 330 formed by the back wall 306 when positioned within sleeve 202 and or housing 201 or 620. The apertures created within the filters described herein are used to manipulate the airflow of particles being captured by the filter. The unique shape is specifically used in assembly 200, 400, 500, and/or 800 so that the air can draw or pull-out air from all areas of the filter. In some embodiments, filters 300 and 700 include a baffle extending across filters, as shown in FIG. 14. It should also be noted that any assembly described herein is intended to be utilized with any housing, sleeve, or filter described herein and in any combination. Likewise, in some applications, any housing can be utilized with any filter without the use of a sleeve.

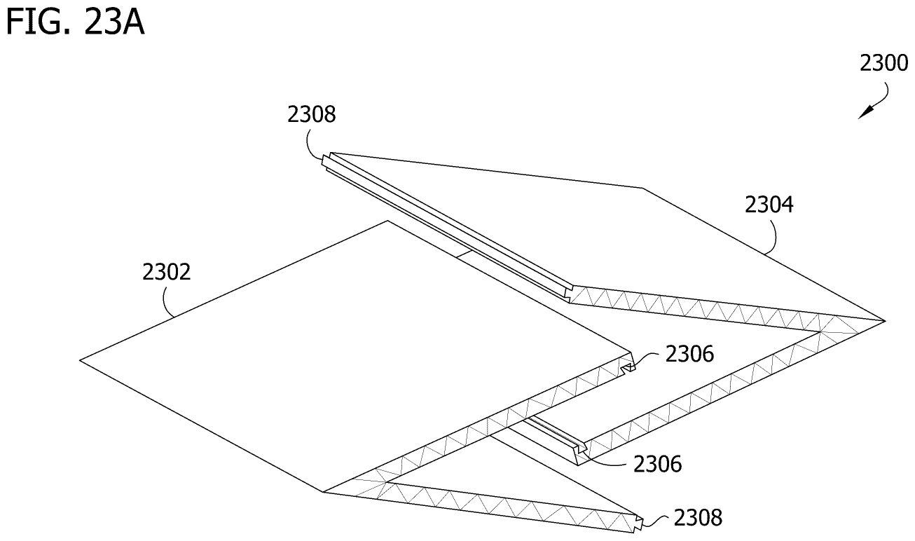

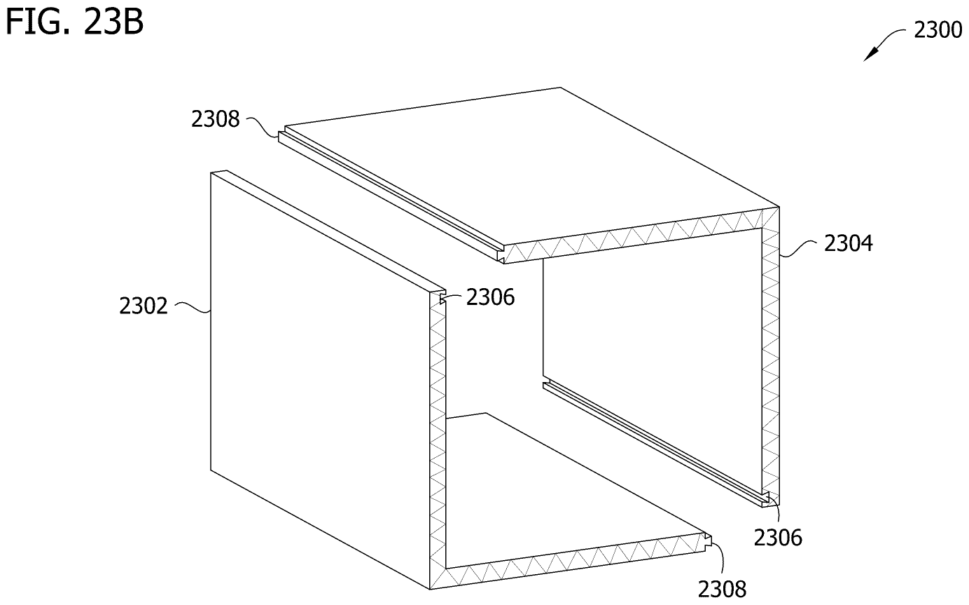

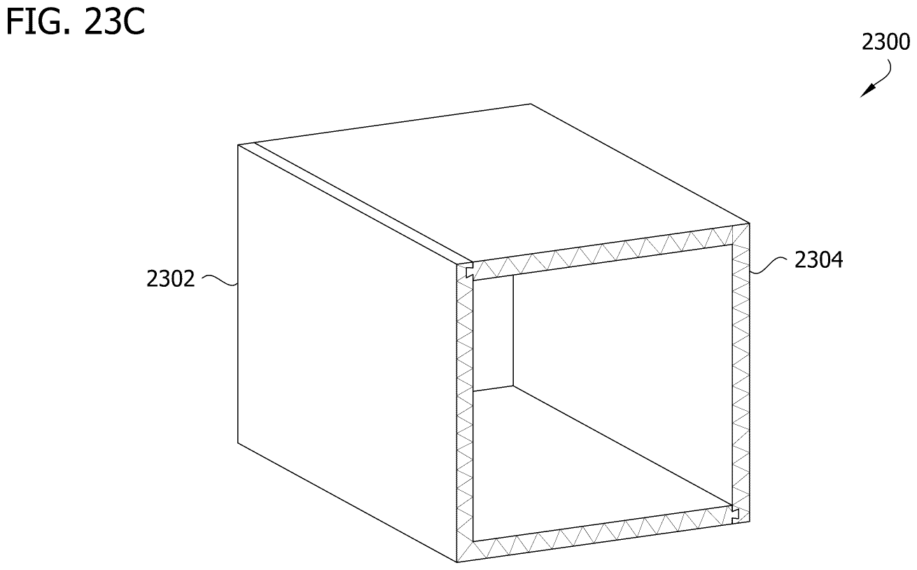

Referring to FIGS. 23A-C a multi-piece filter sleeve 2300 is shown in a compact configuration, a pre-assembly configuration, and an assembled configuration, respectively. The multi-piece filter sleeve 2300 generally comprises a first sleeve portion 2302 and a second sleeve portion 2304. The multiple configurations of the multi-piece sleeve 2300 allow it to be transported in a compact fashion (e.g., with a reduced footprint). For example, in the compact configuration, each of the sleeve portions 2302, 2304 are folded and nested to minimize the space they occupy (e.g., in a shipping container). Perforations along the sleeve portions 2302, 2304 (e.g., at the corners) may be used to facilitate simplified folding without tearing. Each of the sleeve portions 2302, 2304 are configured to be combined (e.g., assembled) to form the assembled configuration. In the illustrated embodiment, each of the sleeve portions 2302, 2304 define a receiving channel 2306 and a protrusion 2308 which are configured to nest such that, when combined, they hold the sleeve portions together. This is shown at FIG. 23C. In alternative embodiments, other connecting means may be used to similar effect.

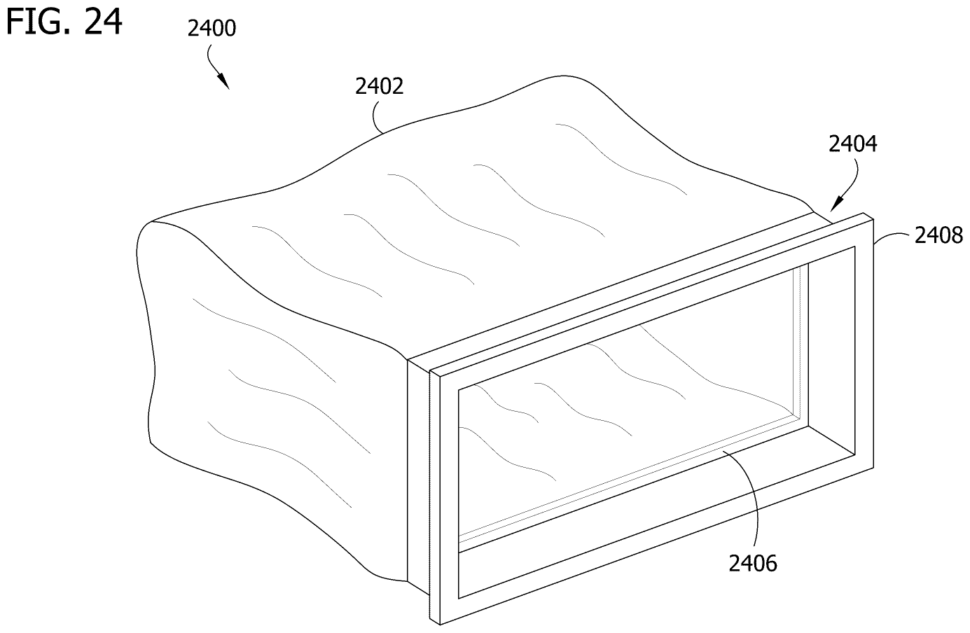

Referring to FIG. 24, a flexible sleeve assembly 2400 is shown. The flexible sleeve assembly 2400 generally comprises a flexible sleeve 2402 and a flexible sleeve retainer 2404. The flexible sleeve 2402 is textile (e.g., fabric) member configured to provide similar benefits to other filter sleeves disclosed above. Specifically, it prevents the accumulation of particulates (e.g., debris, paint) on the cabinet in which it is maintained. The flexible sleeve 2402 connects to the flexible sleeve retainer 2404 and forms a seal therewith. The flexible sleeve 2402 may be connected to the flexible sleeve retainer 2404 via a friction fit, but may also be connected using alternative means. The flexible sleeve retainer 2404 includes an interior flange 2406 for securing a filter. The interior flange 2406 prevents the filter from moving rearward into the cabinet (e.g., when a suction force is provided thereto). The flexible sleeve retainer 2404 also includes an exterior flange 2408 configured to hold the entire flexible sleeve assembly 2400 at a fixed position within the cabinet, and to similarly prevent rearward movement thereof. The flexible sleeve 2402 and flexible sleeve retainer 2404 are configured to promote simplified shipping through the separation and compacting thereof.

While the examples provided herein are applicable to coating (e.g., paint, stain, powder coat) applications, the filtration systems and/or filters described above can be utilized within any system requiring filtering, including but not limited to ventilation systems including, but not limited to, residential and commercial HVAC systems, cement kilns, cement transfer stations, asphalt plants, foundries, lime kilns, coal fired power plant baghouses, fly ash handling, bin vents, wood processing dust collectors, spray driers, aluminum ore processing, steel mills, and food processing plants. Although specific features of various embodiments of the disclosure may be shown in some drawings and not in others, this is for convenience only. In accordance with the principles of the disclosure, any feature of a drawing may be referenced and/or claimed in combination with any feature of any other drawing.

What is claimed is:

1. A filter assembly comprising:
a sleeve sized and configured to retain a filter;
a filter having an upstream side and a downstream side through which air is configured to flow, the filter including at least one sidewall comprising filter media and extending between the upstream side and the downstream side, a back wall comprising filter media and disposed at the downstream side of the main filter, wherein the back wall forms at least one back wall aperture between the back wall and the sleeve; and
a retention member positioned through the filter media adjacent the back wall of the filter and configured to create at least one aperture between a back wall edge and the sleeve to allow air to flow.

2. The filter assembly of claim 1, further comprising a filter retention member positionable in the sleeve and dimensioned to retain the filter within the sleeve.

3. The filter assembly of claim 1, further comprising a baffle configured to be positioned substantially against the filter.

4. The filter assembly of claim 1, further comprising a housing sized to be positioned within a filtration system, and wherein the sleeve is sized to be positioned within the housing.

5. A filter assembly comprising:
a sleeve sized and configured to retain a filter, the sleeve having a number of apertures;
a retention member inserted through the apertures of the sleeve, wherein the retention member is fixedly secured through the sleeve and wherein the retention member is configured to substantially retain a filter when a force is applied to the filter assembly.

6. The filter assembly of claim 5, further comprising:
a filter having an upstream side and a downstream side through which air is configured to flow, the main filter including at least one sidewall comprising filter media and extending between the upstream side and the downstream side, a back wall comprising filter media and disposed at the downstream side of the main filter, wherein the back wall forms at least one back wall aperture between the back wall and the sleeve; and
a retention member positioned through the filter media adjacent the back wall of the filter and configured to create at least one aperture between a back wall edge and the sleeve to allow air to flow.

7. The filter assembly of claim 5, wherein the retention member is a strap.

8. The filter assembly of claim 5, wherein the retention member is secured to itself by ultrasonic welding.

9. The filter assembly of claim 7, wherein the retention member is secured to the sleeve by ultrasonic welding.
